(19) United States
(12) Patent Application Publication
(10) Pub. No.: US 2013/0289187 A1
(43) Pub. Date: Oct. 31, 2013

(54) RESIN COMPOSITION FOR ENCAPSULATION AND ELECTRONIC COMPONENT DEVICE

(71) Applicants: Masahiro Wada, Tokyo (JP); Ken Ukawa, Tokyo (JP); Kenji Yoshida, Tokyo (JP); Yusuke Tanaka, Tokyo (JP)

(72) Inventors: Masahiro Wada, Tokyo (JP); Ken Ukawa, Tokyo (JP); Kenji Yoshida, Tokyo (JP); Yusuke Tanaka, Tokyo (JP)

(73) Assignee: SUMITOMO BAKELITE COMPANY LIMITED, Tokyo (JP)

(21) Appl. No.: 13/880,186

(22) PCT Filed: Oct. 18, 2011
(86) PCT No.: PCT/JP2011/073963

§ 371 Date: Apr. 18, 2013

(30) Foreign Application Priority Data
Oct. 19, 2010 (JP) 2010-234182

(51) Int. Cl. H01B 3/40

(52) U.S. Cl. CPC H01B 3/40
USPC 524/401; 524/540

(57) ABSTRACT

A resin composition for encapsulation according to the present invention includes: a phenol resin-based curing agent (A) essentially containing a polymer component (A-1) in which a biphenylene group-containing structural unit bonds a monovalent hydroxyphenylene structural unit and a polyvalent hydroxyphenylene structural unit together and a polymer component (A-2) in which the biphenylene group-containing structural unit bonds the polyvalent hydroxyphenylene structural units together; an epoxy resin (B); and an inorganic filler (C). This makes it possible to economically obtain a resin composition for encapsulation having soldering resistance, flame resistance, continuous moldability, flowability and high temperature storage stability in an excellent balanced manner, and an electronic component device produced by encapsulating an element with a cured product thereof and having high reliability.

### TECHNICAL FIELD

The present invention is related to a resin composition for encapsulation and an electronic component device.

### RELATED ART

Electronic devices having small sizes, light weights and high performances are constantly required to be developed, and thus an integration degree and a density of elements (hereinafter, referred to as “chips”) are becoming higher year after year. Further, a surface mounting technique is recently developed as a method for manufacturing an electronic component device (hereinafter, referred to as “package”) and spreading widely. Along with these advancements of peripheral technologies of the electronic component device, a resin composition used for encapsulating the elements is also required to have higher properties.

For example, in a surface mounting step, a crack and/or an internal separation occurs due to an explosive stress of water vapor which is generated by rapidly vaporization when the electronic component device absorbing moisture is subjected to high temperature during a soldering process, so that an operation reliability of the electronic component device significantly deteriorates.

Further, in response to gain of momentum toward prohibiting use of lead (Pb), a lead-free solder having a higher melting point than a conventional solder becomes used, so that a mounting temperature of the electronic component device becomes about 20° C. higher than a conventional mounting temperature. As a result, the stress during the soldering process is more serious. Along with the wide spread of the surface mounting technique and the use of the lead-free solder, improvement of soldering resistance is one of the most important technical issues for the resin composition.

Further, a societal demand for prohibiting use of a conventional flame retardant such as a brominated epoxy resin or antimony oxide is increasing against a background of recent environment problems. Thus, it is required to develop a technique for imparting the same flame resistance as such a conventional flame retardant to the resin composition without using the conventional flame retardant.

As an alternate flame retarded technique, proposed is a technique in which an inorganic filler is added to the resin composition in a larger amount by using a crystalline epoxy resin having a low viscosity (see, for example, Patent documents 1 and 2). However, even in the case where the above technique is used, it is difficult to obtain a resin composition sufficiently having the soldering resistance and the flame resistance.

Furthermore, recently, widely used are electronic component devices such as an electronic device for providing in a car or an electronic device for using at outdoor such a cell phone and a semiconductor device in which SiC (silicon carbide) is utilized. Thus, operation reliability thereof under the more severe conditions is required as compared with conventional personal computer and home electric appliances. In particular, in the electronic device for providing in a car or the semiconductor device in which the SiC (silicon carbide) is utilized, high temperature storage life and heat resistance are required as one of necessary requirement properties. For example, it is necessary that the electronic component devices can keep their operations and functions under a high temperature of 150 to 180° C.

As conventional techniques, proposed are a technique for improving the high temperature storage life and soldering resistance of the resin composition by using an epoxy resin having a naphthalene chemical structure and a phenol-based curing agent having a naphthalene chemical structure in combination (see, for example, Patent document 3), and a technique for improving the high temperature storage life and flame resistance of the resin composition by using a phosphorus atom-containing compound (see, for example, Patent documents 4 and 5).

However, even in the case where the above conventional techniques are used, there is a case that it is difficult to obtain a resin composition having flame resistance, continuous moldability and soldering resistance in a sufficient balanced manner. For these reasons, in order to downsize and familiarize in-car electronic equipment, it becomes more important that developed is a resin composition having flame resistance, soldering resistance, high temperature storage life and the continuous moldability in a good balanced manner.

### PRIOR ART DOCUMENT

### Patent Document

Patent document 1: JP-A 2001-207023
Patent document 2: JP-A 2002-212392
Patent document 3: JP-A 2000-273281
Patent document 4: JP-A 2003-292731
Patent document 5: JP-A 2004-43613

### SUMMARY OF THE INVENTION

### Problem to be Solved by the Invention

It is an object of the present invention to economically provide a resin composition for encapsulation having soldering resistance, flame resistance, continuous moldability, flowability and high temperature storage life in an excellent balanced manner, and an electronic component device produced by encapsulating an element with a cured product thereof and having high reliability.

### Means for Solving Problem

A resin composition for encapsulation according to the present invention, comprising:

a phenol resin-based curing agent (A) essentially containing a polymer component (A-1) represented by the following general formula (1) with “k”≧1 and “m”≧1 and a polymer component (A-2) represented by the following general formula (1) with “k”=0 and “m”≧2;

an epoxy resin (B); and

an inorganic filler (C),

wherein a total of relative intensities of peaks derived from the polymer component (A-1) is 5% or more with respect to a total of relative intensities of peaks derived from the whole phenol resin-based curing agent (A) by a field desorption mass spectrometry analysis:

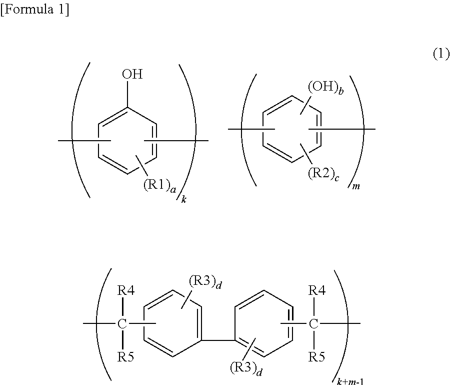

where each of R1 and R2 is independently a hydrocarbon group having a carbon number of 1 to 5, each of R3s is independently a hydrocarbon group having a carbon number or 1 to 10, and each of R4 and R5 is independently a hydrogen atom or a hydrocarbon group having a carbon number of 1 to 10,

“a” is an integer number of 0 to 3, “b” is an integer number of 2 to 4, “c” is an integer number of 0 to 2, and “d” is an integer number of 0 to 4,

each of “k” and “m” is independently an integer number of 0 to 10 and “k”+“m” is 2 or larger,

the monovalent hydroxyphenylene structural unit repeating “k” times and the polyvalent hydroxyphenylene structural unit repeating “m” times continuously, alternately or randomly exist, and

the biphenylene group-containing structural unit repeating “k+m−1” times bonds the monovalent hydroxyphenylene structural units together, the polyvalent hydroxyphenylene structural units together or the monovalent hydroxyphenylene structural unit and the polyvalent hydroxyphenylene structural unit together.

In the phenol resin-based curing agent (A) of the resin composition for encapsulation according to the present invention, a total of relative intensities of peaks derived from the polymer component (A-2) may be 75% or less with respect to the total of relative intensities of the peaks derived from the whole phenol resin-based curing agent (A) by the field desorption mass spectrometry analysis.

In the phenol resin-based curing agent (A) of the resin composition for encapsulation according to the present invention, the total of relative intensities of the peaks derived from the polymer component (A-1) may be in the range of 5 to 80% with respect to the total of relative intensities of the peaks derived from the whole phenol resin-based curing agent (A) and the total of relative intensities of the peaks derived from the polymer component (A-2) may be in the range of 20 to 75% with respect to the total of relative intensities of the peaks derived from the whole phenol resin-based curing agent (A) by the field desorption mass spectrometry analysis.

In the phenol resin-based curing agent (A) of the resin composition for encapsulation according to the present invention, a ratio of an average value “k0” of the numbers “k” of the monovalent hydroxyphenylene structural units included in the polymer components of the phenol resin-based curing agent (A) with respect to an average number “m0” of the numbers “m” of the polyvalent hydroxyphenylene structural units included therein may be in the range of 18/82 to 82/18.

In the phenol resin-based curing agent (A) of the resin composition for encapsulation according to the present invention, the average value “k0” of the numbers “k” of the monovalent hydroxyphenylene structural units included in the polymer components of the phenol resin-based curing agent (A) may be in the range of 0.5 to 2.0.

In the phenol resin-based curing agent (A) of the resin composition for encapsulation according to the present invention, the average value “m0” of the numbers “m” of the polyvalent hydroxyphenylene structural units included in the polymer components of the phenol resin-based curing agent (A) may be in the range of 0.4 to 2.4.

In the resin composition for encapsulation according to the present invention, an amount of the inorganic filler (C) contained in the resin composition for encapsulation may be in the range of 70 to 93 mass % with respect to a total amount of the resin composition for encapsulation.

The resin composition for encapsulation according to the present invention further may comprise a coupling agent (F).

In the resin composition for encapsulation according to the present invention, the coupling agent (F) may contain a silane coupling agent having a secondary amine structure.

In the resin composition for encapsulation according to the present invention, a hydroxyl equivalent of the phenol resin-based curing agent (A) may be in the range of 123 to 190 g/eq.

In the resin composition for encapsulation according to the present invention, the epoxy resin (B) may contain at least one epoxy resin selected from the group constituting of a crystalline epoxy resin, a polyfunctional epoxy resin, a phenolphthalein-type epoxy resin and a phenol aralkyl-type epoxy resin.

The resin composition for encapsulation according to the present invention further may comprise a curing accelerator (D).

In the resin composition for encapsulation according to the present invention, the curing accelerator (D) may contain at least one curing accelerator selected from the group constituting of a tetra-substituted phosphonium compound, a phosphobetaine compound, an adduct of a phosphine compound and a quinone compound and an adduct of a phosphonium compound and a silane compound.

The resin composition for encapsulation according to the present invention further may comprise a compound (E) including an aromatic ring and hydroxyl groups bonding to two or more adjacent carbon atoms constituting the aromatic ring.

The resin composition for encapsulation according to the present invention further may comprise an inorganic flame retardant (G).

In the resin composition for encapsulation according to the present invention, the inorganic flame retardant (G) may contain a metal hydroxide or a composite metal hydroxide.

An electronic component device according to the present invention produced by encapsulating an element with a cured product of the above mentioned resin composition for encapsulation.

### Effects of the Invention

According to the present invention, it is possible to economically obtain a resin composition for encapsulation having soldering resistance, flame resistance, continuous moldability, flowability and high temperature storage life (high temperature storage stability) in an excellent balanced manner, and an electronic component device produced by encapsulating an element with a cured product thereof and having high reliability.

### BRIEF DESCRIPTION OF THE DRAWINGS

FIG. 1 is a view showing a cross section structure of one example of an electronic component device produced using a resin composition for encapsulation according to the present invention.

FIG. 2 is a view showing a cross section structure of one example of a single side-encapsulated type electronic component device produced using a resin composition for encapsulation according to the present invention.

FIG. 3 is a FD-MS chart of a phenol resin-type curing agent 1 used in Example.

FIG. 4 is a FD-MS chart of a phenol resin-type curing agent 2 used in Example.

FIG. 5 is a FD-MS chart of a phenol resin-type curing agent 3 used in Example.

### MODE FOR CARRYING OUT THE INVENTION

A resin composition for encapsulation according to the present invention contains a phenol resin-based curing agent (A) essentially containing a polymer component (A-1) represented by the following general formula (1) with “k”≧1 and “m”≧1 and a polymer component (A-2) represented by the following general formula (1) with “k”=0 and “m”≧2, an epoxy resin (B), and an inorganic filler (C).

The resin composition is characterized in that a total of relative intensities of peaks derived from the polymer component (A-1) is 5% or more with respect to a total of relative intensities of peaks derived from the whole phenol resin-based curing agent (A) by a field desorption mass spectrometry analysis. This makes it possible to obtain a resin composition for encapsulation having soldering resistance, flame resistance, continuous moldability, flowability and high temperature storage life in an excellent balanced manner.

Further, an electronic component device of the present invention is characterized by encapsulating an element with a cured product of the above mentioned resin composition for encapsulation. This makes it possible to economically obtain an electronic component device having high reliability.

In this regard, a numeric range described in this specification includes both an upper limit value and a lower limit value thereof.

First, each component contained in the resin composition for encapsulation according to the present invention will be described in detail.

[Phenol Resin-Based Curing Agent (A)]

The phenol resin-based curing agent (A) to be used in the present invention contains at least one polymer component represented by the following general formula (1). The at least one polymer component (phenol resin-based curing agent (A)) contains a polymer component (A-1) represented by the following general formula (1) with “k”≧1 and “m”≧1 and a polymer component (A-2) represented by the following general formula (1) with “k”=0 and “m”≧2 as essential components thereof.

It is preferred that in the phenol resin-based curing agent (A), a total of relative intensities of peaks derived from the polymer component (A-1) is 5% or more with respect to a total of relative intensities of peaks derived from the whole phenol resin-based curing agent (A) by a field desorption mass spectrometry analysis.

Further, it is more preferred that in the phenol resin-based curing agent (A), a total of relative intensities of peaks derived from the polymer component (A-2) is 75% or less with respect to the total of relative intensities of the peaks derived from the whole phenol resin-based curing agent (A) by the field desorption mass spectrometry analysis.

Furthermore, it is especially preferred that in the phenol resin-based curing agent (A), the total of relative intensities of the peaks derived from the polymer component (A-1) is in the range of 5 to 80% with respect to the total of relative intensities of the peaks derived from the whole phenol resin-based curing agent (A) and the total of relative intensities of the peaks derived from the polymer component (A-2) is in the range of 20 to 75% with respect to the total of relative intensities of the peaks derived from the whole phenol resin-based curing agent (A) by the field desorption mass spectrometry analysis.

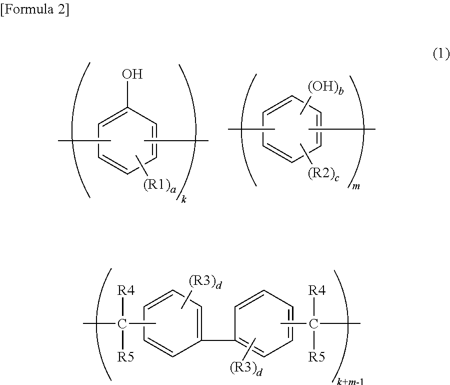

In the general formula (1), each of R1 and R2 is independently a hydrocarbon group having a carbon number of 1 to 5, each of R3s is independently a hydrocarbon group having a carbon number or 1 to 10, and each of R4 and R5 is independently a hydrogen atom or a hydrocarbon group having a carbon number of 1 to 10, “a” is an integer number of 0 to 3, “b” is an integer number of 2 to 4, “c” is an integer number of 0 to 2, “d” is an integer number of 0 to 4, each of “k” and “m” is independently an integer number of 0 to 10, and “k”+“m” is 2 or larger.

The monovalent hydroxyphenylene structural unit (that is, the unit composed of the substituted or non-substituted monovalent hydroxyphenylene structure) repeats “k” times, the polyvalent hydroxyphenylene structural unit (that is, the unit composed of the polyvalent hydroxyphenylene structure) repeats “m” times, and the monovalent hydroxyphenylene structural unit and the polyvalent hydroxyphenylene structural unit continuously, alternately or randomly exist.

Further, the biphenylene group-containing structural unit (that is, the unit composed of the structure containing the substituted or non-substituted biphenylene group) repeats “k+m−1” times and bonds the monovalent hydroxyphenylene structural units together, the polyvalent hydroxyphenylene structural units together or the monovalent hydroxyphenylene structural unit and the polyvalent hydroxyphenylene structural unit together.

The substituted or non-substituted monovalent hydroxyphenylene structure constitutes the monovalent hydroxyphenylene structural unit repeating “k” times in the general formula (1), and means a phenylene structure having one hydroxyl group and having substituent group(s) other than the hydroxyl group or no substituent group. Further, the polyvalent hydroxyphenylene structure constitutes the polyvalent hydroxyphenylene structural unit repeating “m” times in the general formula (1), and means a phenylene structure having two to four hydroxyl groups and having no substituent group other than the hydroxyl groups.

Furthermore, the structure containing the substituted or non-substituted biphenylene group constitutes the biphenylene group-containing structural unit repeating “k+m−1” times in the general formula (1), and is a bonding group which bonds the monovalent hydroxyphenylene structural units together, the polyvalent hydroxyphenylene structural units together or the monovalent hydroxyphenylene structural unit and the polyvalent hydroxyphenylene structural unit together.

In this regard, in the case where the monovalent hydroxyphenylene structural unit and the polyvalent hydroxyphenylene structural unit are positioned at an end of a molecule of the polymer component, one of the two bonding groups thereof is terminated with a hydrogen atom.

Examples of a polymer having a structure in which the monovalent hydroxyphenylene structural unit and the biphenylene group-containing structural unit alternately exist include a phenol aralkyl-type polymer including biphenylene group. The resin composition containing such a phenol aralkyl-type polymer can exhibit excellent flame resistance, low hygroscopicity and soldering resistance. These properties are considered to be obtained due to the effect of the substituted or non-substituted biphenylene group included in the biphenylene group-containing structural unit.

Further, in the phenol resin-based curing agent (A) to be used in the present invention, the polymer component further includes the polyvalent hydroxyphenylene structural unit in addition to the monovalent hydroxyphenylene structural unit of the above mentioned phenol aralkyl-type polymer including biphenylene group. The existence of such a polyvalent hydroxyphenylene structural unit makes a density of the hydroxyl group higher in the polymer component. As a result, it is possible to improve reactivity, curability, heat resistance and hot hardness of the resin composition, and high temperature storage life of an electronic component device such as a semiconductor device.

Further, the use of such a phenol resin-based curing agent (A) makes it possible to suppress defects such as a microscopic damage which would occur in a cured product of the resin composition at an air vent portion of a mold during continuous molding thereof, that is, to improve continuous moldability of the resin composition. This is likely to be because bias in density of cross-linked points to be formed by reaction with epoxy groups occurs due to the coexistence of the monovalent hydroxyphenylene structure and the polyvalent hydroxyphenylene structure in one molecule of the polymer component, and thus the resin composition can exhibit good toughness at a mold temperature during continuous molding thereof.

As described above, the polymer component of the phenol resin-based curing agent (A) includes the monovalent hydroxyphenylene structural unit, the polyvalent hydroxyphenylene structural unit and the biphenylene group-containing structural unit positioning therebetween. This makes it possible to economically obtain a resin composition having flowability, soldering resistance, flame resistance, heat resistance, high temperature storage life and continuous moldability in an excellent balanced manner.

The phenol resin-based curing agent (A) essentially contains the polymer component (A-1) represented by the general formula (1) with “k”≧1 and “m”≧1 and the polymer component (A-2) represented by the general formula (1) with “k”=0 and “m”≧2. By using such a phenol resin-based curing agent (A) as a curing agent, it is possible to obtain a resin composition whose cured product exhibits sufficient hardness or toughness at an air vent or gate portion and which has good continuous moldability. Therefore, even in the case where an organic substrate such as BGA is used, the resin composition also can exhibit improved continuous moldability.

Further, the use of such a resin composition makes it possible to exhibit an effect of suppressing warpage of a single side-encapsulated type package (PKG). Therefore, the above resin composition is appropriately used in a single side-encapsulated type semiconductor device such as BGA, CSP or MAPBGA. Further, the above resin composition is also appropriately used in various packages such as a package for providing in a car, a package in which a SiC element is utilized and a package mounting a power system element (e.g., a power transistor) such as TO-220.

The phenol resin-based curing agent (A) contains the at least one polymer component represented by the general formula (1) including the monovalent hydroxyphenylene structural unit and the polyvalent hydroxyphenylene structural unit, but may contain the polymer component (A-1) having represented by the general formula (1) with “k”≧1 and “m”≧1, the polymer component (A-2) represented by the general formula (1) with “k”=0 and “m”≧2 and a polymer component (A-3) represented by the general formula (1) with “k”≧2 and “m”=0.

A ratio of these polymer components contained in the phenol resin-based curing agent (A) can be determined by a field desorption mass spectrometry (FD-MS) analysis. Specifically, the ratio can be defined as a ratio of percentages of the polymer components each obtained by dividing a total of relative intensities (detected intensities) of peaks derived from each polymer component by a total of relative intensities (detected intensities) of peaks derived from the whole phenol resin-based curing agent (A). A preferable range of the ratio is as follows.

In the phenol resin-based curing agent (A), a total of relative intensities of peaks derived from the polymer component (A-1) represented by the general formula (1) with “k”≧1 and “m”≧1 is preferably 5% or more, more preferably 10% or more, and even more preferably 15% or more with respect to the total of relative intensities of the peaks derived from the whole phenol resin-based curing agent (A). If the total of relative intensities of the peaks derived from the polymer component (A-1) is larger than the lower limit value, the obtained resin composition has excellent heat resistance and temperature storage life and sufficient toughness at a molding temperature, and thus can exhibit superior continuous moldability.

Further, an upper limit value of a ratio of the polymer component (A-1) contained in the phenol resin-based curing agent (A) is not limited to a specific value, but the total of relative intensities of the peaks derived therefrom is preferably 80% or less, more preferably 60% or less, and even more preferably 45% or less with respect to the total of relative intensities of the peaks derived from the whole phenol resin-based curing agent (A). If the total of relative intensities of the peaks derived from the polymer component (A-1) is smaller than the upper limit value, the resin composition can have excellent soldering resistance.

In the phenol resin-based curing agent (A), a total of relative intensities of peaks derived from the polymer component (A-2) is preferably 75% or less, and more preferably 70% or less with respect to the total of relative intensities of the peaks derived from the whole phenol resin-based curing agent (A). If the total of relative intensities of the peaks derived from the polymer component (A-2) is smaller than the upper limit value, the obtained resin composition has excellent flowability and soldering resistance and sufficient toughness at a molding temperature, and thus can exhibit superior continuous moldability.

Further, a lower limit value of a ratio of the polymer component (A-2) contained in the phenol resin-based curing agent (A) is not limited to a specific value, but a total of relative intensities of the peaks derived therefrom is preferably 20% or more, and more preferably 25% or more with respect to the total of relative intensities of the peaks derived from the whole phenol resin-based curing agent (A). If the total of relative intensities of the peaks derived from the polymer component (A-2) is larger than the lower limit value, the resin composition can exhibit excellent high temperature storage life.

An upper limit value of a ratio of the polymer component (A-3) contained in the phenol resin-based curing agent (A) is not limited to a specific value, but a total of relative intensities of the peaks derived therefrom is preferably 70% or less, and more preferably 60% or less with respect to the total of relative intensities of the peaks derived from the whole phenol resin-based curing agent (A). If the total of relative intensities of the peaks derived from the polymer component (A-3) is smaller than the upper limit value, the obtained resin composition can exhibit excellent heat resistance, high temperature storage life and continuous moldability.

Further, a lower limit value of a ratio of the polymer component (A-3) contained in the phenol resin-based curing agent (A) is not limited to a specific value, but a total of relative intensities of the peaks derived therefrom is preferably 1% or more, and more preferably 2% or more with respect to the total of relative intensities of the peaks derived from the whole phenol resin-based curing agent (A). If the total of relative intensities of the peaks derived from the polymer component (A-3) is larger than the lower limit value, the resin composition can exhibit good soldering resistance and flowability.

By using the phenol resin-based curing agent (A) containing the plurality of polymer components having different structures at the ratios falling within the above ranges, it is possible to obtain a resin composition for encapsulation having flowability, soldering resistance, flame resistance, heat resistance, high temperature storage life and continuous moldability in a good balanced manner.

In the phenol resin-based curing agent (A), an average value “k0” of the numbers “k” of the monovalent hydroxyphenylene structural units included in the polymer components and an average number “m0” of the numbers “m” of the polyvalent hydroxyphenylene structural units included therein can be calculated as follows. First, the total of relative intensities (detected intensities) of the peaks derived from each of the polymer components in the mass spectrum is divided by the total of relative intensities of peaks derived from the whole phenol resin-based curing agent (A) therein, to calculate a mass ratio of the polymer components. Next, the mass ratio is divided by molecular weights of the polymer components, respectively, to bring into a molar ratio thereof.

Thereafter, this molar ratio is multiplied by the number “k” of the monovalent hydroxyphenylene structural unit and the number “m” of the polyvalent hydroxyphenylene structural unit included in each polymer component, and then the multiplied “k”s and the multiplied “m”s are added to each other, respectively. As a result, a sum of the multiplied “k”s becomes the average value “k0” and a sum of the multiplied “m”s becomes the average value “m0”, respectively.

In the phenol resin-based curing agent (A) to be used in the present invention, a ratio of the average value “k0” of the numbers “k” of the monovalent hydroxyphenylene structural units included in the polymer components with respect to the average number “m0” of the numbers “m” of the polyvalent hydroxyphenylene structural units included therein (that is, a ratio of a percent value of “k0” calculated by k0/(k0+m0)×100 with respect to a percent value of “m0” calculated by m0/(k0+m0)×100) is not limited to a specific value, but is preferably in the range of 18/82 to 82/18, more preferably in the range of 20/80 to 80/20, and even more preferably in the range of 25/75 to 75/25. In the case where the ratio of the average values of the numbers of both the structural units is within the above range, it is possible to economically obtain a resin composition having flowability, soldering resistance, flame resistance, heat resistance, high temperature storage life and continuous moldability in an excellent balanced manner.

If k0/m0 is smaller than the upper limit value, the obtained resin composition has excellent heat resistance and high temperature storage life and sufficient toughness at a molding temperature, and thus can exhibit superior continuous moldability. On the other hand, if k0/m0 is larger than the lower limit value, the obtained resin composition has excellent flame resistance and flowability and sufficient toughness at a molding temperature, and thus can exhibit superior continuous moldability.

In the phenol resin-based curing agent (A) to be used in the present invention, the average value “k0” is preferably in the range of 0.5 to 2.0, more preferably in the range of 0.6 to 1.9, and even more preferably in the range of 0.7 to 1.8. On the other hand, the average value “m0” is preferably in the range of 0.4 to 2.4, more preferably in the range of 0.6 to 2.0, and even more preferably in the range of 0.7 to 1.9.

If the average value “k0” is larger than the lower limit value, the obtained resin composition can exhibit excellent heat resistance, high temperature storage life and continuous moldability. Further, if the average value “m0” is larger than the lower limit value, the obtained resin composition has excellent heat resistance and high temperature storage life and sufficient toughness at a molding temperature, and thus can exhibit superior continuous moldability. On the other hand, if the average value “m0” is smaller than the upper limit value, the obtained resin composition has excellent flame resistance and flowability and sufficient toughness at a molding temperature, and thus can exhibit superior continuous moldability.

Further, the sum of the average values “k0” and “m0” is preferably in the range of 2.0 to 3.5, and more preferably in the range of 2.2 to 2.7. If the sum of the average values “k0” and “m0” is larger than the lower limit value, the obtained resin composition can exhibit excellent heat resistance, continuous moldability and high temperature storage life. On the other hand, if the sum of the average values “k0” and “m0” is smaller than the upper limit value, the obtained resin composition can exhibit excellent flowability.

In this regard, the average values “k0” and “m0” can be obtained by an arithmetic calculation considering the relative intensity ratio of the polymer components based on the FD-MS analysis as the mass ratio thereof, but also can be obtained based on H-NMR or C-NMR measurement.

For example, in the case where the H-NMR measurement is used, from a ration of a signal derived from a hydrogen atom in a hydroxyl group and a signal derived from hydrogen atoms in an aromatic ring, a ratio of (k0+m0×b) and (2k0+2m0−1) can be calculated. By solving the system of equations including the ratio of (k0+m0×b) and (2k0+2m0−1), and {k×(molecular weight of monovalent hydroxyphenylene structural unit)+m×(molecular weight of polyvalent hydroxyphenylene structural unit)+(k+m−1)×(molecular weight of biphenylene group-containing structural unit)}/(k0+m0×b)=hydroxyl equivalent, the average values “k0” and “m0” can be calculated. In this regard, if “b” is unknown, it can be obtained using a pyrolysis mass spectrometry analysis.

Alternatively, the average values “k0” and “m0” also can be obtained by an arithmetic calculation considering the relative intensity ratio of the polymer components based on the FD-MS analysis as the mass ratio thereof.

In the phenol resin-based curing agent (A), each of R1 and R2 included in the general formula (1) is a hydrocarbon group having a carbon number of 1 to 5, and may be the same or different from each other. Each of R1 and R2 is not limited to a specific hydrocarbon group, as long as it has the carbon number of 1 to 5. If the carbon number of each of R1 and R2 is 5 or less, it is possible to suppress moldability of the obtained resin composition for encapsulation which would occur due to decrease of reactivity thereof from lowering.

Examples of each of R1 and R2 include a methyl group, an ethyl group, a propyl group, a n-butyl group, an isobutyl group, a t-butyl group, a n-pentyl group, a 2-methyl butyl group, a 3-methyl butyl group, a t-pentyl group and the like. In the case where each of R1 and R2 is the methyl group, the resin composition for encapsulation can exhibit curability and hydrophobicity in an excellent balanced manner.

Further, “a” represents the number of the substituent group R1 bonding to the same benzene ring, and is independently an integer number of 0 to 3, and more preferably an integer number of 0 to 1. “c” represents the number of the substituent group R2 bonding to the same benzene ring, and is independently an integer number of 0 to 2, and more preferably an integer number of 0 to 1.

“b” represents the number of the hydroxyl group bonding to the same benzene ring, and is independently an integer number of 2 to 4, more preferably an integer number of 2 to 3, and even more preferably an integer number of 2.

In the phenol resin-based curing agent (A), R3 included in the structure represented by the general formula (1) is a hydrocarbon group having a carbon number of 1 to 10, and may be the same or different from each other. If the carbon number of R3 is 10 or less, it is possible to suppress flowability of the resin composition for encapsulation which would occur due to increase of a melt viscosity thereof from lowering. R3 included in the general formula (1) is not limited to a specific hydrocarbon group, as long as it has the carbon number of 1 to 10.

Examples of R3 include a methyl group, an ethyl group, a propyl group, a n-butyl group, an isobutyl group, a t-butyl group, a n-pentyl group, a 2-methyl butyl group, a 3-methyl butyl group, a t-pentyl group, a n-hexyl group, a 1-methyl pentyl group, a 2-methyl pentyl group, a 3-methyl pentyl group, a 4-methyl pentyl group, a 2,2-dimethyl butyl group, a 2,3-dimethyl butyl group, a 2,4-dimethyl butyl group, a 3,3-dimethyl butyl group, a 3,4-dimethyl butyl group, a 4,4-dimethyl butyl group, a 2-ethyl butyl group, a 1-ethyl butyl group, a cyclohexyl group, a phenyl group, a benzyl group, a methyl benzyl group, an ethyl benzyl group, a naphthyl group and the like.

Further, “d” represents the number of the substituent group R3 bonding to the same benzene ring, and is independently an integer number of 0 to 4, and more preferably an integer number of 0 to 1.

In the phenol resin-based curing agent (A), each of R4 and R5 included in the general formula (1) is a hydrogen atom or a hydrocarbon group having a carbon number of 1 to 10, and may be the same or different from each other. If the carbon number of each of R4 and R5 is 10 or less, it is possible to suppress flowability of the resin composition for encapsulation which would occur due to increase of a melt viscosity thereof from lowering. Each of R4 and R5 included in the general formula (1) is not limited to a specific hydrocarbon group, as long as it has the carbon number of 1 to 10.

Examples of each of R4 and R5 include a methyl group, an ethyl group, a propyl group, a n-butyl group, an isobutyl group, a t-butyl group, a n-pentyl group, a 2-methyl butyl group, a 3-methyl butyl group, a t-pentyl group, a n-hexyl group, a 1-methyl pentyl group, a 2-methyl pentyl group, a 3-methyl pentyl group, a 4-methyl pentyl group, a 2,2-dimethyl butyl group, a 2,3-dimethyl butyl group, a 2,4-dimethyl butyl group, a 3,3-dimethyl butyl group, a 3,4-dimethyl butyl group, a 4,4-dimethyl butyl group, a 2-ethyl butyl group, a 1-ethyl butyl group, a cyclohexyl group, a phenyl group, a benzyl group, a methyl benzyl group, an ethyl benzyl group, a naphthyl group and the like.

For example, the polymer component (phenol resin-based curing agent (A)) represented by the general formula (1) can be obtained by reacting a biphenylene compound represented by the following general formula (2) and/or general formula (3) with a monovalent phenol compound represented by the following general formula (4) and a polyvalent phenol compound represented by the following general formula (5) under the acid catalyst.

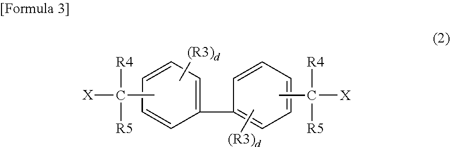

where “X” is a hydroxyl group, a halogen atom or an alkoxy group having a carbon number of 1 to 6. R3, R4, R5 and d follow the descriptions of the general formula (1).

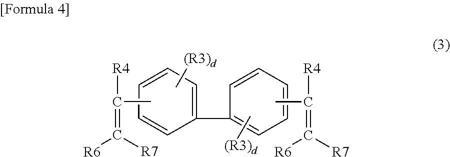

where each of R6 and R7 is independently a hydrogen atom or a hydrocarbon group having a carbon number of 1 to 9. A total carbon number of R6 and R7 is in the range of 0 to 9. R3, R4 and d follow the descriptions of the general formula (1).

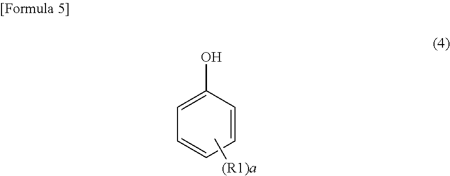

where R1 and “a” follow the descriptions of the general formula (1).

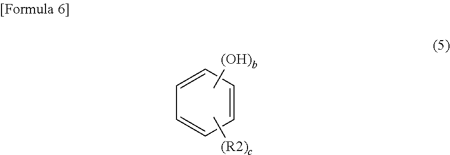

where R2, “b” and “c” follow the descriptions of the general formula (1).

In “X” included in the biphenylene compound represented by the general formula (2) used for producing the polymer component, examples of the halogen atom include a fluorine atom, a chlorine atom, a bromine atom, an iodine atom and the like. Examples of the alkoxy group having the carbon number of 1 to 6 include a methoxy group, an ethoxy group, a propoxy group, a n-butoxy group an isobutoxy group, a t-butoxy group, a n-pentoxy group, a 2-methyl butoxy group, a 3-methyl butoxy group, a t-pentoxy group, a n-hexoxy group, a 1-methyl pentoxy group, a 2-methyl pentoxy group, a 3-methyl pentoxy group, a 4-methyl pentoxy group, 2,2-dimethyl butoxy group, 2,3-dimethyl butoxy group, 2,4-dimethyl butoxy group, a 3,3-dimethyl butoxy group, a 3,4-dimethyl butoxy group, a 4,4-dimethyl butoxy group, a 2-ethyl butoxy group, a 1-ethyl butoxy group and the like.

Examples of “═CR6R7 (alkylidene group)” included in the biphenylene compound represented by the general formula (3) used for producing the polymer component include a methylidene group, an ethylidene group, a propylidene group, a n-butylidene group, a isobutylidene group, a t-butylidene group, a n-pentylidene group, a 2-methyl butylidene group, a 3-methyl butylidene group, a t-pentylidene group, a n-hexylidene group, a 1-methyl pentylidene group, a 2-methyl pentylidene group, a 3-methyl pentylidene group, a 4-methyl pentylidene group, a 2,2-dimethyl butylidene group, a 2,3-dimethyl butylidene group, a 2,4-dimethyl butylidene group, a 3,3-dimethyl butylidene group, a 3,4-dimethyl butylidene group, a 4,4-dimethyl butylidene group, a 2-ethyl butylidene group, a 1-ethyl butylidene group, a cyclohexylidene and the like.

The biphenylene compound used for producing the polymer component is not limited to a specific compound, as long as it is represented by the general formula (2) or (3). Example of the biphenylene compound include, but are not limited to, 4,4′-bischloromethyl biphenyl, 4,4′-bisbromomethyl biphenyl, 4,4′-bisiodinemethyl biphenyl, 4,4′-bishydroxymethyl biphenyl, 4,4′-bismethoxymethyl biphenyl, 3,3′,5,5′-tetramethyl-4,4′-bischloromethyl biphenyl, 3,3′,5,5′-tetramethyl-4,4′-bisbromomethyl biphenyl, 3,3′,5,5′-tetramethyl-4,4′-bisiodinemethyl biphenyl, 3,3′,5,5′-tetramethyl-4,4′-bishydroxymethyl biphenyl, 3,3′,5,5′-tetramethyl-4,4′-bismethoxymethyl biphenyl and the like. Further, one of them may be used alone, or two or more of them may be used in combination.

Among them, the 4,4′-bismethoxymethyl biphenyl is preferable from the viewpoint that it can be synthesized at a relatively low temperature, and a reaction by-product can be easily distilled away and handled. Further, the 4,4′-bischloromethyl biphenyl is also preferable from the viewpoint that a hydrogen halide which would be generated due to existence of a small amount of moisture can be used as an acid catalyst.

The monovalent phenol compound used for producing the polymer component is not limited to a specific compound, as long as it is represented by the general formula (4). Example of the monovalent phenol compound include, but are not limited to, phenol, o-cresol, p-cresol, m-cresol, phenyl phenol, ethyl, phenol, n-propyl phenol, isopropyl phenol, t-butyl phenol, xylenol, methyl propyl phenol, methyl butyl phenol, dipropyl phenol, dibutyl phenol, nonyl phenol, mesitol, 2,3,5-trimethyl phenol, 2,3,6-trimethyl phenol and the like. Further, one of them may be used alone, or two or more of them may be used in combination.

Among them, the phenol and the o-cresol are preferable, and the phenol is more preferable from the viewpoint that it has high reactivity with the epoxy resin. In the production of the polymer component, one of these phenol compounds may be used alone, or two or more of them may be used in combination.

Examples of the polyvalent phenol compound used for producing the polymer component include, but are not limited to, resorcinol, catechol, hydroquinone, chloroglucinol, pyrogallol, 1,2,4-benzenetriol and the like. Further, one of them may be used alone, or two or more of them may be used in combination. Among them, the resorcinol and the hydroquinone are preferable from the viewpoint that the resin composition can have high reactivity, and the resorcinol is more preferable from the viewpoint that the polymer component can be synthesized at a relatively low temperature.

Examples of the acid catalyst used for producing the polymer component include, but are not limited to, formic acid, oxalic acid, p-toluenesulfonic acid, trifluoromethanesulfonic acid, hydrochloric acid, sulfuric acid, phosphoric acid, acetic acid, Lewis acid and the like. Further, in the case where each of “X” and “Y” included in the biphenylene compound represented by the general formula (2) is the halogen atom, since a hydrogen halide generated during reaction serves as an acid catalyst, the reaction can be promptly started with adding a small amount of water and no acid catalyst into the reaction system.

A method of synthesizing the polymer component of the phenol resin-based curing agent (A) is not particularly limited. For example, the polymer component can be synthesized by reacting 1 mol of the monovalent and polyvalent phenol compounds, 0.05 to 0.8 mols of the biphenylene compound and 0.01 to 0.05 mols of the acid catalyst with each other at a temperature of 80 to 170° C. for 1 to 20 hours, while discharging the generated gas and moisture outside the reaction system by nitrogen flow, and then by distilling away residual unreacted monomers (e.g., a benzyl compound, a dihydroxynaphthalene compound), reaction by-products (e.g., a hydrogen halide, methanol) and the catalyst using a reduced pressure distillation method or a steam distillation method.

With regard to mixing ratios of the monovalent phenol compound and the polyvalent phenol compound, the mixing ratio of the monovalent phenol compound is preferably in the range of 15 to 85 mol %, more preferably in the range of 20 to 80 mol %, and even more preferably in the range of 25 to 75 mol % with respect to 100 mol % of a total amount of the monovalent phenol compound and the polyvalent phenol compound.

If the mixing ratio of the monovalent phenol compound is lower than the above upper limit value, the obtained resin composition has excellent heat resistance and high temperature storage life and sufficient toughness at a molding temperature, and thus can exhibit superior continuous moldability. On the other hand, if the mixing ratio of the monovalent phenol compound is higher than the lower limit value, increase of a raw material cost is prevented, or the obtained resin composition has excellent flowability, soldering resistance and flame resistance and sufficient toughness at a molding temperature, and thus can exhibit superior continuous moldability.

By setting the mixing ratios of the two kinds of the phenol compounds within the above ranges, it is possible to economically obtain a resin composition for encapsulation having flowability, soldering resistance, flame resistance, heat resistance, high temperature storage life and continuous moldability in a good balanced manner

Here, the average values “k0” and “m0” of the numbers “k” and “m”, the ratio thereof and the sum thereof are controlled as follows. The average values “k0” and “m0” of the numbers “k” and “m” reflect the mixing ratios of the monovalent phenol compound and the polyvalent phenol compound used for synthesizing the polymer component of the phenol resin-based curing agent (A). Therefore, by adjusting the mixing ratios in the synthesis, the ratio of the average values “k0” and “m0” of the numbers “k” and “m” can be controlled.

Further, by using a method in which the mixing amount of the biphenylene compound is increased, the mixing amount of the catalyst is increased or the reaction temperature is heightened in synthesizing the polymer component of the phenol resin-based curing agent (A), the sum of the average values “k0” and “m0” of the numbers “k” and “m” can be raised. By appropriately combining the above adjusting methods to each other, the average values “k0” and “m0” of the numbers “k” and “m” can be controlled.

By using a method in which the mixing amount of the biphenylene compound is decreased, the mixing amount of the catalyst is decreased, the hydrogen halide gas which would be generated is promptly discharged outside the system by the nitrogen gas stream or the reaction temperature is lowered, to thereby suppress production of a high molecular weight component, it is possible to obtain a phenol resin-based curing agent (A) containing a polymer component having a lower viscosity.

In this case, the procession of the reaction can be confirmed by checking a gas such as a hydrogen halide or alcohol, which would be generated as a by-product due to the reaction of the biphenylene compound represented by the general formula (2) with the monovalent phenol compound and/or the polyvalent phenol compound, or by measuring a molecular weight of a product sampled during the reaction using a gel permeation chromatography method.

A lower limit value of a hydroxyl equivalent of the phenol resin-based curing agent (A) is not limited to a specific value, but is preferably 90 g/eq or more, and more preferably 100 g/eq or more. If the hydroxyl equivalent is higher than the lower limit value, the obtained resin composition can exhibit excellent continuous moldability and heat resistance.

On the other hand, an upper limit value of the hydroxyl equivalent of the phenol resin-based curing agent (A) is preferably 190 g/eq or less, more preferably 180 g/eq or less, and even more preferably 170 g/eq or less. If the hydroxyl equivalent is lower than the upper limit value, the obtained resin composition can exhibit excellent heat resistance, high temperature storage life and continuous moldability.

An upper limit value of a softening point of the phenol resin-based curing agent (A) is not limited to a specific value, but is preferably 110° C. or lower, and more preferably 105° C. or lower. If the softening point is lower than the upper limit value, the phenol resin-based curing agent (A) can be promptly melted by being heated in the production of the resin composition, to thereby obtain the resin composition in high productivity.

On the other hand, a lower limit value of the softening point of the phenol resin-based curing agent (A) is not limited to a specific value, but is preferably 55° C. or higher, and more preferably 60° C. or higher. If the softening point is higher than the lower limit value, the obtained resin composition hardly occurs blocking, and thus can exhibit excellent continuous moldability.

A mixing amount of the phenol resin-based curing agent (A) is preferably in the range of 0.5 to 10 mass %, more preferably in the range of 2 to 8 mass %, and even more preferably in the range of 4 to 7.5 mass %. If the mixing amount is within the above range, the obtained resin composition can exhibit curability, heat resistance and soldering resistance in an excellent balanced manner.

The resin composition for encapsulation according to the present invention may contain the other curing agent in combination with the phenol resin-based curing agent (A) at a level that the effects thereof is not vitiated. Examples of the curing agent to be combined include, but are not limited to, a polyaddition-type curing agent, a catalyst-type curing agent, a condensation-type curing agent and the like.

Examples of the polyaddition-type curing agent include: an aliphatic polyamine such as diethylenetriamine, triethylenetetramine or metaxylenediamine; an aromatic polyamine such as diaminodiphenyl methane, m-phenylenediamine, diaminodiphenyl sulfone; a polyamine compound such as dicyandiamide or an organic acid dihydrazide; an acid anhydride such as an alicyclic acid anhydride (e.g., hexahydrophthalic acid anhydride, methyl tetrahydrophthalic acid anhydride) or an aromatic acid anhydride (e.g., trimellitic acid anhydride, pyromellitic acid anhydride, benzophenone tetracarboxylic acid); a polyphenol compound such as a novolac-type phenol resin or a phenol polymer; a polymercaptan compound such as polysulphide, thioester or thioether; an isocyanate compound such as an isocyanate prepolymer or a blocked isocyanate; an organic acid such as a carboxylic acid containing polyester resin; and the like.

Examples of the catalyst-type curing agent include: a tertiary amine compound such as benzyl dimethyl amine or 2,4,6-trisdimethyl aminomethyl phenol; an imidazole compound such as 2-methyl imidazole or 2-ethyl-4-methyl imidazole; a Lewis acid such as BF₃ complex; and the like.

Examples of the condensation-type curing agent include: a phenol resin-type curing agent such as a novolac-type phenol resin or a resol-type phenol resin; an urea resin such as a methylol group-containing urea resin; a melamine resin such as a methylol group-containing melamine resin; and the like.

Among them, the phenol resin-type curing agent is preferable from the viewpoint of having flame resistance, moisture resistance, an electrical property, curability and storage stability in a good balanced manner. The phenol resin-type curing agent is a monomer, an oligomer and a polymer each having two or more phenolic hydroxyl groups in one molecule thereof, but a molecular weight and a molecular structure thereof is not particularly limited.

Examples of the phenol resin-type curing agent include: a novolac-type resin such as a phenol novolac resin, a cresol novorak resin or a naphthol novorak resin; a polyfunctional-type phenol resin such as a triphenol methane-type phenol resin; a modified phenol resin such as a terpene-modified phenol resin or a dicyclopentadiene-modified phenol resin; an aralkyl-type resin such as a phenol aralkyl resin having a phenylene chemical structure and/or a biphenylene chemical structure or a naphthol aralkyl resin having a phenylene chemical structure and/or biphenylene chemical structure; a bisphenol compound such as bisphenol A or bisphenol F; and the like. Further, one of them may be used alone, or two or more of them may be used in combination. Among them, a compound having a hydroxyl equivalent of 90 to 250 g/eq is preferable from the viewpoint of having good curability.

In the case where the other curing agent is used in combination with the phenol resin-based curing agent (A), a mixing ratio of the phenol resin-based curing agent (A) is preferably 25 mass % or more, more preferably 35 mass % or more, and even more preferably 45 mass % or more with respect to the whole curing agent. If the mixing ratio is a value falling within the above range, it is possible to improve flame resistance and high temperature storage life of the resin composition, while maintaining good continuous moldability thereof.

A lower limit value of a mixing ratio of the whole curing agent is not limited to a specific value, but is preferably 0.8 mass % or more, and more preferably 1.5 mass % or more with respect to the whole resin composition. If the lower limit value of the mixing ratio is within the above range, the resin composition can exhibit sufficient flowability. Further, an upper limit value of the mixing ratio of the whole curing agent is not also limited to a specific value, but is preferably 10 mass % or less, and more preferably 8 mass % or less with respect to the whole resin composition. If the upper limit value of the mixing ratio is within the above range, the resin composition can obtain good soldering resistance.

The epoxy resin (B) used for the resin composition for encapsulation according to the present invention has a function of curing the resin composition by being cross-linked via the phenol resin-based curing agent (A).

Examples of such an epoxy resin (B) include: but are not limited to; a crystalline epoxy resin such as a biphenyl-type epoxy resin, a bisphenol-type epoxy resin, a stilbene-type epoxy resin, a sulfide-type epoxy resin or a dihydroxyanthracene-type epoxy resin; a novolac-type epoxy resin such as a methoxynaphthalene chemical structure-containing novolac-type epoxy resin, a phenolnovolac-type epoxy resin or a cresol novolac-type epoxy resin; a phenol-modified aromatic hydrocarbon-formaldehyde resin-type epoxy resin obtained by modifying a resin synthesized through condensation of an aromatic hydrocarbon and formaldehyde with phenol, and then epoxidizing it; a polyfunctional epoxy resin such as a triphenol methane-type epoxy resin, an alkyl-modified triphenol methane-type epoxy resin or a tetrakishydroxyphenyl ethane-type epoxy resin; an aralkyl-type epoxy resin such as a phenol aralkyl-type epoxy resin having a phenylene chemical structure or a phenol aralkyl-type epoxy resin having a biphenylene chemical structure; a naphthol-type epoxy resin such as a dihydroxynaphthalene-type epoxy resin, an epoxy resin obtained by glycidyletherating a dimer of dihydroxynaphthalene; a triazinen-chemical structure-containing epoxy resin such as triglycidyl isocyanurate or monoallyl glycidyl isocyanurate; a bridged cyclic hydrocarbon compound-modified phenol-type epoxy resin such as a dicyclopentadiene-modified phenol-type epoxy resin; and a phenolphthalein-type epoxy resin obtained by reacting phenolphthalein and epichlorohydrin with each other.

The crystalline epoxy resin is preferable from the viewpoint that the resin composition can exhibit excellent flowability, the polyfunctional epoxy resin is preferable from the viewpoint that the resin composition can exhibit good high temperature storage life (HTSL) and contamination of a mold by the resin composition can be made small during continuous molding thereof, and the phenolphthalein-type epoxy resin is preferable from the viewpoint that the resin composition can exhibit flame resistance, high temperature storage life (HTSL) and soldering resistance in an excellent balanced manner in the case where an amount of a filling agent contained therein is small.

The epoxy resin such as the aralkyl-type epoxy resin (e.g., the phenol aralkyl-type epoxy resin having the phenylene chemical structure, the phenol aralkyl-type epoxy resin having the biphenylene chemical structure) or the phenol-modified aromatic hydrocarbon-formaldehyde-type epoxy resin is preferable from the viewpoint that the resin composition can exhibit soldering resistance, the epoxy resin including the naphthalene chemical structure in its molecule such as the naphthol-type epoxy resin or the methoxynaphthalene chemical structure-containing novolac-type epoxy resin is preferable from the viewpoint that the resin composition can exhibit flame resistance and high temperature storage life (HTSL) in an excellent balanced manner.

Further, the epoxy resin (B) may contain an epoxy resin (polymer) represented by the following general formula (B1) as one kind of a phenol aralkyl-type epoxy resin including a biphenylene chemical structure. Such a polymer includes a monovalent glycidylated phenylene structural unit repeating “p” times and a polyvalent glycidylated phenylene structural unit repeating “q” times. This causes increase of a density of the epoxy groups in the polymer.

This makes it possible to increase a cross-linking density of a cured product to be produced by cross-linking the epoxy resin via the phenol resin-based curing agent (A). As a result, it is possible to improve a glass transition temperature (Tg) of such a cured product.

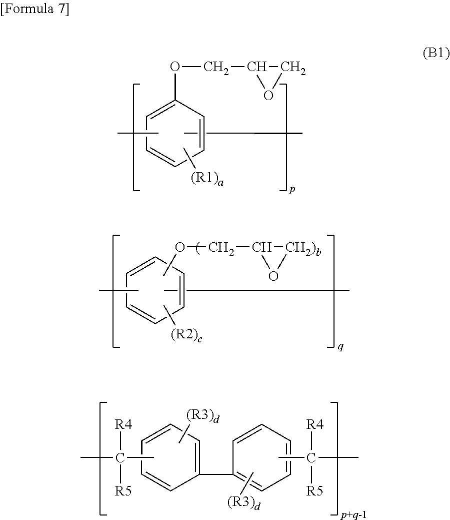

where each of R1 and R2 is independently a hydrocarbon group having a carbon number of 1 to 5, each of R3s is independently a hydrocarbon group having a carbon number of 1 to 10, and each of R4 and R5 is independently a hydrogen atom or a hydrocarbon group having a carbon number of 1 to 10,

“a” is an integer number of 0 to 3, “b” is an integer number of 2 to 4, “c” is an integer number of 0 to 2, and “d” is an integer number of 0 to 4,

each of “p” and “q” is independently an integer number of 0 to 10 and “p”+“q” is 2 or larger,

a monovalent glycidylated phenylene structural unit repeating “p” times and a polyvalent glycidylated phenylene structural unit repeating “m” times continuously, alternately or randomly exist, and

a biphenylene group-containing structural unit repeating “p+q−1” times bonds the monovalent glycidylated phenylene structural units together, the polyvalent glycidylated phenylene structural units together or the monovalent glycidylated phenylene structural unit and the polyvalent glycidylated phenylene structural unit together.

In the epoxy resin, each of R1 and R2 included in the general formula (B1) is independently a hydrogen atom or a hydrocarbon group having a carbon number of 1 to 5. In the case where each of R1 and R2 is the hydrocarbon group, if the carbon number thereof is 5 or less, it is possible to suppress moldability of the obtained resin composition which would occur due to decrease of reactivity thereof from lowering.

Specifically, examples of each of R1 and R2 include a methyl group, an ethyl group, a propyl group, a n-butyl group, an isobutyl group, a t-butyl group, a n-pentyl group, a 2-methyl butyl group, a 3-methyl butyl group, a t-pentyl group and the like. Among them, the methyl group is preferable, this makes it possible for the resin composition to exhibit curability and hydrophobicity in an excellent balanced manner.

Further, “a” represents the number of the substituent group R1 bonding to the same benzene ring, and is independently an integer number of 0 to 3, and more preferably an integer number of 0 to 1. “c” represents the number of the substituent group R2 bonding to the same benzene ring, and is independently an integer number of 0 to 2, and more preferably an integer number of 0 to 1.

“b” represents the number of the glycidylether group bonding to the same benzene ring, and is independently an integer number of 2 to 4, more preferably an integer number of 2 to 3, and even more preferably an integer number of 2.

In the epoxy resin (B), R3 included in the general formula (B1) is a hydrocarbon group having a carbon number of 1 to 10, and may be the same or different from each other. If the carbon number of R3 is 10 or less, it is possible to suppress flowability of the resin composition for encapsulation which would occur due to increase of a melt viscosity thereof from lowering. R3 included in the general formula (B1) is not limited to a specific hydrocarbon group, as long as it has the carbon number of 1 to 10.

Examples of R3 include a methyl group, an ethyl group, a propyl group, a n-butyl group, an isobutyl group, a t-butyl group, a n-pentyl group, a 2-methyl butyl group, a 3-methyl butyl group, a t-pentyl group, a n-hexyl group, a 1-methyl pentyl group, a 2-methyl pentyl group, a 3-methyl pentyl group, a 4-methyl pentyl group, a 2,2-dimethyl butyl group, a 2,3-dimethyl butyl group, a 2,4-dimethyl butyl group, a 3,3-dimethyl butyl group, a 3,4-dimethyl butyl group, a 4,4-dimethyl butyl group, a 2-ethyl butyl group, a 1-ethyl butyl group, a cyclohexyl group, a phenyl group, a benzyl group, a methyl benzyl group, an ethyl benzyl group, a naphthyl group and the like.

Further, “d” represents the number of the substituent group R3 bonding to the same benzene ring, and is independently an integer number of 0 to 4, and more preferably an integer number of 0 to 1.

In the epoxy resin (B), each of R4 and R5 included in the general formula (B1) is a hydrogen atom or a hydrocarbon group having a carbon number of 1 to 10, and may be the same or different from each other. In the case where each of R4 and R5 is 10 is the hydrocarbon group, if the carbon number thereof is 10 or less, it is possible to suppress flowability of the resin composition for encapsulation which would occur due to increase of a melt viscosity thereof from lowering. In the case where each of R4 and R5 is the hydrocarbon group, the carbon number thereof in not limited to a specific value, as long as it is in the range of 1 to 10.

Examples of each of R4 and R5 include a methyl group, an ethyl group, a propyl group, a n-butyl group, an isobutyl group, a t-butyl group, a n-pentyl group, a 2-methyl butyl group, a 3-methyl butyl group, a t-pentyl group, a n-hexyl group, a 1-methyl pentyl group, a 2-methyl pentyl group, a 3-methyl pentyl group, a 4-methyl pentyl group, a 2,2-dimethyl butyl group, a 2,3-dimethyl butyl group, a 2,4-dimethyl butyl group, a 3,3-dimethyl butyl group, a 3,4-dimethyl butyl group, a 4,4-dimethyl butyl group, a 2-ethyl butyl group, a 1-ethyl butyl group, a cyclohexyl group, a phenyl group, a benzyl group, a methyl benzyl group, an ethyl benzyl group, a naphthyl group and the like.

The epoxy resin represented by such a general formula (B1) includes the glycidyl etherated phenyl group having the one glycidyl ether group and the glycidyl etherated phenyl group having the plurality of glycidyl ether groups.

In the case where the epoxy resin includes the glycidyl etherated phenyl group having the one glycidyl ether group, the resin composition can exhibit excellent flame resistance, low water absorption and soldering resistance.

Further, in the case where the epoxy resin includes the glycidyletherated phenyl group having the plurality of glycidylether groups, it is possible to increase a density of the glycidylether groups, and thus heighten a glass transition temperature (Tg) of a cured product of the resin composition. Here, in the case where a density of the glycidylether groups included in the epoxy resin represented by the general formula (B1) becomes high, a weight loss ratio of the epoxy resin tends to heighten.

However, in a cross-linked product of the phenol resin-based curing agent (A) and the epoxy resin represented by the general formula (B1), a methylene group portion bonding the biphenyl chemical structure and the monovalent or divalent phenol structure together is considered to be protected due to a stereoscopic bulkiness thereof, to thereby be relatively difficult to be thermally decomposed. By the fact, the weight loss ratio of the epoxy resin is considered to hardly increase despite heightening the glass transition temperature (Tg) of the cured product.

In the epoxy resin, an average value “p0” of the numbers “p” of the monovalent glycidylated phenylene structural units included in the epoxy resins is preferably in the range of 0 to 2.0, more preferably in the range of 0.5 to 1.8, and even more preferably in the range of 0.6 to 1.6. If the average value “p0” is larger than the above lower limit value, the obtained resin composition can exhibit excellent flame resistance and flowability. On the other hand, if the average value “p0” is smaller than the upper limit value, the obtained resin composition can exhibit excellent heat resistance and flowability.

In the epoxy resin, an average value “q0” of the numbers “q” of the polyvalent glycidylated phenylene structural units included in the polymers is preferably in the range of 0.4 to 3.6, more preferably in the range of 0.6 to 2.0, and even more preferably in the range of 0.8 to 1.9. If the average value “q0” is larger than the above lower limit value, the obtained resin composition has excellent heat resistance and sufficient hardness at a molding temperature, and thus can exhibit superior moldability. On the other hand, if the average value “q0” is smaller than the above upper limit value, the obtained resin composition has excellent flame resistance and flowability and sufficient toughness at a molding temperature, and thus can exhibit superior moldability.

“p0/q0” which is a ratio of “p0” with respect to “q0” is preferably in the range of 0/100 to 82/18, more preferably in the range of 20/80 to 80/20, and even more preferably in the range of 25/75 to 75/25. In the case where “p0/q0” is within the above range, it is possible to economically obtain a resin composition having flowability, soldering resistance, flame resistance and moldability in a good balanced manner. If the “p0/q0” is smaller than the above upper limit value, the obtained resin composition has excellent heat resistance and sufficient hardness at a molding temperature, and thus can exhibit superior moldability.

Further, “p0+q0” which is a sum of “p0” and “q0” is preferably in the range of 2.0 to 3.6, and more preferably in the range of 2.2 to 2.7. If the “p0+q0” is larger than the above lower limit value, the obtained resin composition can exhibit excellent heat resistance and moldability. On the other hand, if the “p0+q0” is smaller than the above upper limit value, the obtained resin composition can exhibit superior flowability.

In this regard, the values “p0” and “q0” can be obtained by an arithmetic calculation considering a relative intensity ratio of the polymer components based on FD-MS analysis as a mass ratio thereof. Further, they also can be obtained based on H-NMR or C-NMR measurement.

For example, the epoxy resin represented by the above general formula (B1) can be obtained as follows.

Namely, the epoxy resin represented by the above general formula (B1) can be obtained by preparing the polymer component (phenol resin-based curing agent (A)) represented by the above general formula (1), and then reacting the hydroxyl groups included in the polymer component with epichlorohydrin to change the hydroxyl groups to the glycidyl ether groups.

More specifically, excess epichlorohydrin is added to the polymer component represented by the above general formula (1). Thereafter, they are reacted with each other under the existence of an alkali metal hydroxide such sodium hydroxide or potassium hydroxide, at a temperature range of preferably 50 to 150° C. and more preferably 60 to 120° C., for a time of about 1 to 10 hours.

After the completion of reaction, a residue obtained by removing the excess epichlorohydrin through distillation is dissolved into an organic solvent such as methyl isobutyl ketone to obtain a solution, the solution is filtered and washed with water to remove inorganic salts therefrom, and then the organic solvent is removed from the solution to thereby obtain the epoxy resin.

An additive amount of the epichlorohydrin is set to preferably about 2 to 15 mol times, and more preferably about 2 to 10 mol times with respect to a hydroxyl equivalent of the polymer component. Further, an additive amount of the alkali metal hydroxide is set to preferably about 0.8 to 1.2 mol times and more preferably about 0.9 to 1.1 mol times with respect to the hydroxyl equivalent of the polymer component.

An upper limit value and a lower limit value of an epoxy equivalent of the epoxy resin represented by the above general formula (B1) are preferably defined based on a theoretical value calculated assuming that all the hydroxyl groups of the polymer component are changed to the glycidyl ether groups. However, in the case where a part of the hydroxyl groups is not changed to the glycidyl ether group, these values have only to be 85% of the theoretical value. This is because even in such a case, the effects of the present invention can be exhibited.

Specifically, the lower limit value of the epoxy equivalent of the epoxy resin represented by the above general formula (B1) is set to preferably 150 g/eq or more, and more preferably 170 g/eq or more. Further, the upper limit value of the epoxy equivalent of the epoxy resin represented by the above general formula (B1) is set to a preferably 290 g/eq or less, more preferably 260 g/eq or less, and even more preferably 240 g/eq or less.

By setting the lower limit value and the upper limit value within the above ranges, the number of cross-linked points produced by reacting the epoxy groups with the hydroxyl groups is adjusted within a preferable range. This causes the effects of the present invention of hardly increasing the weight loss ratio of the epoxy resin despite heightening the glass transition temperature (Tg) of the cured product.

Further, it is preferred that the resin composition for encapsulation does not contain ionic impurities such as a Na ion and a Cl ion as far as possible from the viewpoints of improving moisture proof reliability thereof.

An amount of the epoxy resin (B) contained in the resin composition for encapsulation is preferably 2 mass % or more, and more preferably 4 mass % or more with respect to a total mass of the resin composition for encapsulation. If the lower limit value is within the above range, the obtained resin composition can have satisfactory flowability. Further, the amount of the epoxy resin (B) contained in the resin composition for encapsulation is preferably 15 mass % or less, and more preferably 13 mass % or less with respect to the total mass of the resin composition for encapsulation. If the upper limit value is within the above range, the obtained resin composition can have satisfactory soldering resistance.

In this regard, it is preferred that the phenol resin-based curing agent (A) and the epoxy resin (B) are mixed with each other so that (EP)/(OH), which is a equivalence ratio of the number (EP) of the epoxy groups of all the epoxy resins with respect to the number (OH) of the phenolic hydroxyl groups of all the phenol resin-based curing agents, is in the range of 0.8 to 1.3. If the equivalence ratio is within the above range, the obtained resin composition can exhibit sufficient curability during molding thereof.

[Inorganic Filler (C)]

As an inorganic filler (C) used for the resin composition for encapsulation according to the present invention, an inorganic filler well known in the present field can be used. Examples of the inorganic filler (C) include fused silica, spherical silica, crystal silica, alumina, silicon nitride, aluminum nitride and the like. It is preferred that a particle size of the inorganic filler (C) is in the range of 0.01 to 150 μm from the viewpoints of maintaining filling efficiency of the resin composition into a cavity of a mold.

A lower limit value of an amount of the inorganic filler (C) contained in the resin composition for encapsulation is preferably 70 mass % or more, more preferably 78 mass % or more, and even more preferably 81 mass % or more with respect to the total mass of the resin composition. If the lower limit value is within the above range, it is possible to suppress increasing of a moisture absorption amount and lowering of hardness of the obtained resin composition which would occur with being cured. This makes it possible to obtain a cured product thereof having good solder cracking resistance. Further, in this case, there is also little fear that molding defects of the resin composition are generated due to clogging thereof at a mold gate during continuous molding thereof.

On the other hand, an upper limit value of the amount of the inorganic filler (C) contained in the resin composition for encapsulation is preferably 93 mass % or less, more preferably 91 mass % or less, and even more preferably 90 mass % or less with respect to the total mass of the resin composition. If the upper limit value is within the above range, the obtained resin composition can have good flowability and excellent moldability.

In this regard, in the case where an inorganic fire retardant described below such as a metal hydroxide (e.g., aluminum hydroxide, magnesium hydroxide), zinc borate, zinc molybdate or antimonous oxide is used, it is preferred that a total amount of the inorganic fire retardant and the above inorganic filler is set within the above range.

[Other Components]

The resin composition for encapsulation according to the present invention may contain a curing accelerator (D). As the curing accelerator (D), a well known curing accelerator can be used as long as it can accelerate the reaction of the epoxy group of the epoxy resin (B) and the phenolic hydroxyl group of the phenol resin-based curing agent (A).

Concrete examples of such a curing accelerator (D) include: a phosphorus atom-containing compound such as an organic phosphine, a tetra-substituted phosphonium compound, a phosphobetaine compound, an adduct of a phosphine compound and a quinone compound or an adduct of a phosphine compound and a silane compound; or a nitrogen atom-containing compound such as 1,8-diazabicyclo[5,4,0]undecene-7, benzyl dimethyl amine or 2-methyl imidazole.

Among them, the phosphorus atom-containing compound is preferable from the viewpoints of imparting high curability to the resin composition. The phosphobetaine compound or the adduct of the phosphine compound and the quinone compound is more preferable from the viewpoints of imparting good soldering resistance and flowability to the resin composition, and the phosphorus atom-containing compound such as the tetra-substituted phosphonium compound or the adduct of the phosphine compound and the silane compound is more preferable from the viewpoints of making contamination of a mold by the resin composition slight during continuous molding thereof.

Examples of the organic phosphine which can be used in the present invention include: a primary phosphine such as ethyl phosphine or phenyl phosphine; a secondary phosphine such as dimethyl phosphine or diphenyl phosphine; and a tertiary phosphine such as trimethyl phosphine, triethyl phosphine, tributyl phosphine or triphenyl phosphine.

Examples of the tetra-substituted phosphonium compound which can be used in the present invention include a compound represented by the following general formula (6) and the like.

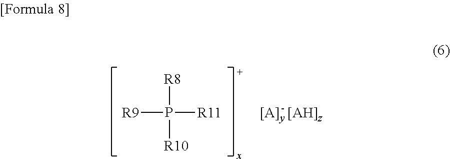

where “P” is a phosphorus atom, each of R8, R9, R10 and R11 is an aromatic group or an alkyl group, “A” is an anion of an aromatic organic acid having an aromatic ring to which at least one functional group selected from a hydroxyl group, a carboxyl group and a thiol group is bonded, “AH” is an aromatic organic acid having an aromatic ring to which at least one functional group selected from a hydroxyl group, a carboxyl group and a thiol group is bonded, each of “x” and “y” is an integer number of 1 to 3, “z” is an integer number of 0 to 3, and “x” is equal to “y”.

For example, the compound represented by the general formula (6) can be obtained as follows, but the method of obtaining such a compound is not particularly limited. First, a tetra-substituted phosphonium halide, an aromatic organic acid and a base are uniformly mixed with an organic solvent to generate an aromatic organic acid anion in a solution system. Next, water is added to the solution system to thereby obtain the precipitated compound represented by the general formula (6).

In the compound represented by the general formula (6), it is preferred that each of R1, R2, R3 and R4 bonded to the phosphorus atom is a phenyl group, “AH” is a phenol compound having an aromatic ring to which a hydroxyl group is bonded, and “A” is an anion of the phenol compound. Examples of such a phenol compound in the present invention include a monocyclic phenol compound such as phenol, cresol, resorcin or catechol; a fused polycyclic phenol compound such as naphthol, dihydroxynaphthalene or anthraquinol; a bisphenol compound such as bisphenol A, bisphenol F or bisphenol S; a polycyclic phenol compound such as phenyl phenol or biphenol; and the like.

Examples of the phosphobetaine compound which can be used in the present invention include a compound represented by the following general formula (7).

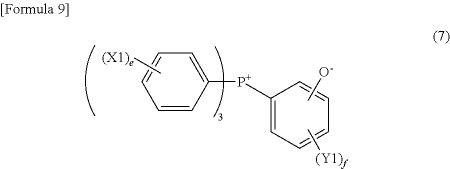

where X1 is an alkyl group having a carbon number of 1 to 3, Y1 is a hydroxyl group, “e” is an integer number of 0 to 5, and “f” is an integer number of 0 to 3.

For example, the compound represented by the general formula (7) can be obtained as follows. Namely, the compound can be obtained by bringing a tri-aromatic substituted phosphine which is the tertiary phosphine into contact with a diazonium salt, to thereby substitute the tri-aromatic substituted phosphine with a diazonium group of the diazonium salt. However, the method of obtaining such a compound is not limited thereto.

Examples of the adduct of the phosphine compound and the quinone compound which can be used in the present invention include a compound represented by the following general formula (8).

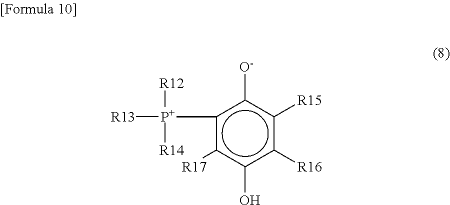

where “P” is a phosphorus atom, each of R12, R13 and R14 is an alkyl group having a carbon number of 1 to 12 or an aryl group having a carbon number of 6 to 12 and is the same or different from each other, each of R15, R16 and R17 is a hydrogen atom or a hydrocarbon group having a carbon number 1 to 12 and is the same or different from each other, and R15 may be bonded to R16 to form a cyclic structure.

As the phosphine compound used for producing such an adduct of the phosphine compound and the quinone compound, preferable is a phosphine compound having a non-substituted aromatic ring or a substituted aromatic ring with a substituent group (e.g., an alkyl group, an alkoxyl group) such as triphenyl phosphine, tris(alkyl phenyl)phosphine, tris(alkoxyphenyl)phosphine, trinaphthyl phosphine, tris(benzyl)phosphine or the like. Examples of the substituent group include a group having a carbon number of 1 to 6 such as an alkyl group or an alkoxyl group. From the viewpoints of ease availability thereof, the triphenyl phosphine is preferable.

Further, as the quinone compound used for producing the adduct of the phosphine compound and the quinone compound, preferable is o-benzoquinone, p-benzoquinone or an anthraquinone compound. From the viewpoints of improving storage stability of the resin composition, the p-benzoquinone is preferable.

The adduct of the phosphine compound and the quinone compound can be obtained by bringing the organic tertiary phosphine and the benzoquinone into contact with each other in a solvent capable of dissolving both of them, and then mixing them with each other. Examples of the solvent include, but are not limited to, ketones having low solubility for the adduct such as acetone and methyl ethyl ketone.

Preferable is a compound represented by the general formula (8) in which each of R11, R12 and R13 bonded to the phosphorus atom is a phenyl group and each of R14, R15 and R16 is a hydrogen atom, that is, a compound produced by adding 1,4-benzoquinone to triphenyl phosphine from the viewpoints of lowering a thermal elastic modulus (elastic modulus at higher temperature) of the cured product of the resin composition for encapsulation.

Examples of the adduct of the phosphine compound and the silane compound which can be used in the present invention include a compound represented by the following general formula (9).

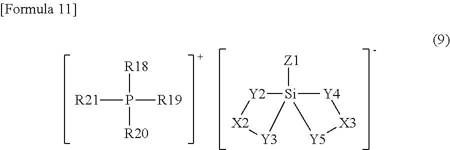

In the above general formula (9), “P” is a phosphorus atom, “Si” is a silicon atom, and each of R18, R19, R20 and R21 is an organic group having an aromatic ring or a heterocyclic ring, or an aliphatic group, and is the same or different from each other. “X2” is an organic group through which “Y2” and “Y3” are bonded together. “X3” is an organic group through which “Y4” and “Y5” are bonded together.

Each of “Y2” and “Y3” is a group obtained by releasing protons from a proton-donating group and is bonded to the silicon atom contained in the same molecular to form a chelate structure. Each of “Y4” and “Y5” is a group obtained by releasing protons from a proton-donating group and is bonded to the silicon atom contained in the same molecular to form a chelate structure.

Each of “X2” and “X3” is the same or different from each other. Each of “Y2”, “Y3”, “Y4” and “Y5” is the same or different from each other. “Z1” is an organic group having an aromatic ring or a heterocyclic ring, or an aliphatic group.

In the general formula (9), examples of each of R18, R19, R20 and R21 include a phenyl group, a methyl phenyl group, a methoxyphenyl group, a hydroxyphenyl group, a naphthyl group, a hydroxynaphthyl group, a benzyl group, a methyl group, an ethyl group, a n-butyl group, a n-octyl group, a cyclohexyl group and the like. Among these groups, an aromatic group having a substituent group such as the phenyl group, the methyl phenyl group, the methoxyphenyl group, the hydroxyphenyl group, the hydroxynaphthyl group or the like, or a non-substituted aromatic group is preferable.

Further, in the general formula (9), “X2” is the organic group through which “Y2” and “Y3” are bonded together. Similarly, “X3” is the organic group through which “Y4” and “Y5” are bonded together. Each of “Y2” and “Y3” is the group obtained by releasing protons from the proton-donating group and is bonded to the silicon atom contained in the same molecular to form the chelate structure. Similarly, each of “Y4” and “Y5” is the group obtained by releasing protons from the proton-donating group and is bonded to the silicon atom contained in the same molecular to form the chelate structure. Each of “X2” and “X3” is the same or different from each other. Each of “Y2”, “Y3”, “Y4” and “Y5” is the same or different from each other.

A group represented by —Y2-X2-Y3- or —Y4-X3-Y5- in the general formula (9) is composed of a group obtained by releasing two protons from a proton-donor. As the proton-donor, an organic acid containing at least two carboxyl groups and/or hydroxyl groups is preferable, an aromatic compound containing at least two or more carboxyl groups or hydroxyl groups each bonded to carbon atoms constituting an aromatic ring is more preferable, and an aromatic compound containing an aromatic ring and at least two hydroxyl groups bonded to adjacent carbon atoms constituting an aromatic ring is even more preferable.

Examples of such an aromatic compound include catechol, pyrogallol, 1,2-dihydroxynaphthalene, 2,3-dihydroxynaphthalene, 2,2′-biphenol, 1-1′-bi-2-naphthol, salicylic acid, 1-hydroxy-2-naphthoic acid, 3-hydroxy-naphthoic acid, chloranilic acid, tannic acid, 2-hydroxybenzylalchol, 1,2-cyclohexanediol, 1,2-propanediol, glycerin and the like. Among them, the catechol, the 1,2-dihydroxynaphthalene or 2,3-dihydroxynaphthalene is preferable.

Further, “Z1” in the general formula (9) is an organic group having an aromatic ring or a heterocyclic ring, or an aliphatic group. Concrete examples of such a group include an aliphatic hydrocarbon group such as a methyl group, an ethyl group, a propyl group, a butyl group, a hexyl group or an octyl group; an aromatic hydrocarbon group such as a phenyl group, a benzyl group, a naphthyl group or a biphenyl group; a reactive substituent group such as a glycidyl oxypropyl group, a mercaptopropyl group, an aminopropyl group or a vinyl group; and the like.

Among them, the methyl group, the ethyl group, the phenyl group, the naphthyl group or the biphenyl group is preferable from the viewpoints of improving thermal stability of the adduct represented by the general formula (9).

The adduct of the phosphine compound and the silane compound can be obtained as follows. First, a silane compound such as phenyl trimethoxysilane and a proton donator such as 2,3-dihydroxynaphthalene are added to a flask into which methanol is put and dissolved therein. Next, a sodium methoxide-methanol solution is dropped thereto under a room temperature with being stirred.

Thereafter, when a solution, which has been, in advance, prepared by dissolving a tetra-substituted phosphonium halide such as tetraphenyl phosphonium bromide into methanol, is dropped thereto under a room temperature with being stirred, a crystal is precipitated therefrom. The precipitated crystal is filtered, washed with water and vacuum dried. In this way, the adduct of the phosphine compound and the silane compound is obtained. However, the method of obtaining such an adduct is not limited thereto.

A mixing ratio of the curing accelerator (D) is preferably in the range of 0.1 to 1 mass % with respect to the whole resin composition. If the mixing ratio of the curing accelerator (D) is within the above range, the resin composition can obtain sufficient curability. Further, if the mixing ratio of the curing accelerator (D) is within the above range, the resin composition also can obtain good flowability.

In the present invention, a compound (E) including an aromatic ring and hydroxyl groups bonding to two or more adjacent carbon atoms constituting the aromatic ring can be used. By using such a compound (E) including the aromatic ring and the hydroxyl groups bonding to the two or more adjacent carbon atoms constituting the aromatic ring (hereinafter, referred to as “compound (E)”), it is possible to suppress a cross-linking reaction of the phenol resin-based curing agent (A) with the epoxy resin (B) in the resin composition during melting and kneading thereof, even in the case where a phosphorus atom-containing curing accelerator having no latent is used as a curing accelerator for accelerating the cross-linking reaction thereof.

This makes it possible to mold the resin composition under the high shearing condition, to thereby improve flowability thereof. Further, this also makes it possible to prevent embossing of a releasing agent on a package surface during continuous molding of the resin composition, or to suppress accumulating of the releasing agent on a mold surface, to thereby reduce a cleaning cycle of the mold.

Further, the compound (E) exhibits an effect of lowering a melt viscosity of the resin composition for encapsulation, to thereby improve flowability thereof and also exhibits an effect of improve soldering resistance although its detail mechanism is not known. As the compound (E), a monocyclic compound represented by the following formula (10) or a polycyclic compound represented by the following formula (11) can be used, and these compound may include constituent group(s) other than the hydroxyl group.

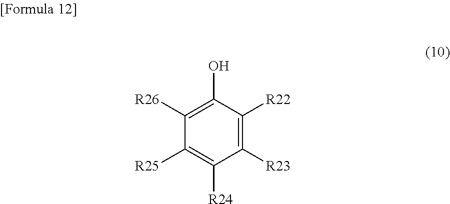

where any one of R22 and R26 is a hydroxyl group. In the case where one group is the hydroxyl group, the other group is a hydrogen atom, a hydroxyl group or a substituent group other than the hydroxyl group. Each of R23, R24 and R25 is a hydrogen atom, a hydroxyl group or a substituent group other than the hydroxyl group.

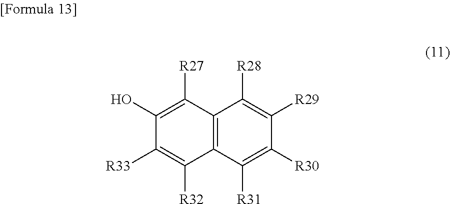

where any one of R27 and R33 is a hydroxyl group. In the case where one group is the hydroxyl group, the other group is a hydrogen atom, a hydroxyl group or a substituent group other than the hydroxyl group. Each of R28, R29, R30, R31 and R32 is a hydrogen atom, a hydroxyl group or a substituent group other than the hydroxyl group.

Concrete examples of the monocyclic compound represented by the general formula (10) include catechol, pyrogallol, gallic acid, gallic acid ester and derivatives thereof. Further, concrete examples of the polycyclic compound represented by the general formula (11) include 1,2-dihydroxynaphthalene, 2,3-dihydroxynaphthalene and derivatives thereof. Among them, a compound including an aromatic ring and hydroxyl groups each bonding to two adjacent carbon atoms constituting the aromatic ring is preferable from the viewpoints of easily controlling flowability and curability of the resin composition.

Further, a compound including a phthalene ring having low volatility and high weighing stability as a main structure thereof is preferable from the viewpoints of preventing volatilization of the compound (E) during a kneading step. In this case, specifically, the compound including the phthalene ring such as 1,2-dihydroxynaphthalene, 2,3-dihydroxynaphthalene or derivative thereof can be used as the compound (E). Further, one of them may be used alone, or two or more of them may be used in combination as the compound (E).

A mixing ratio of the compound (E) is preferably in the range of 0.01 to 1 mass %, more preferably in the range of 0.03 to 0.8 mass %, and even more preferably in the range of 0.05 to 0.5 mass % with respect to the whole resin composition. If the lower limit value of the mixing ratio of the compound (E) is within the above range, it is possible to exhibit effects of sufficiently lowering a viscosity of the resin composition and improving flowability thereof. On the other hand, if the upper limit value of the mixing ratio of the compound (E) is within the above range, there is little fear to cause lowering of curability of the resin composition or properties of a cured product thereof.

The resin composition for encapsulation according to the present invention may contain a coupling agent (F) such as a silane coupling agent in order to improve adhesiveness between the epoxy resin (B) and the inorganic filler (C). Further improvement of heat resistance and high temperature storage life of the obtained resin composition is helped by increasing the average number “m0” of the numbers “m” of the polyvalent hydroxyphenylene structural units included in the polymer components each represented by the general formula (1) of the phenol resin-based curing agent (A). However, in this case, there is a fear that flowability of the resin composition and soldering resistance of an electronic component device in which a metal lead frame is used are lowered.

In such a case, by using aminosilane is used as the coupling agent (F), it is possible to the flowability and the soldering resistance of the resin composition. Examples of the aminosilane include, but are not limited to, γ-aminopropyl triethoxysilane, γ-aminopropyl trimethoxysilane, N-β(aminoethyl) γ-aminopropyl trimethoxysilane, N-β(aminoethyl) γ-aminopropyl methyl dimethoxysilane, N-phenyl γ-aminopropyl triethoxysilane, N-phenyl γ-aminopropyl trimethoxysilane, N-β(aminoethyl) β-aminopropyl triethoxysilane, N-6-(aminohexyl) 3-aminopropyl trimethoxysilane, N-(3-(trimethoxysilyl propyl)-1,3-benzene dimethanamine, and the like.

Generally, the aminosilane exhibits excellent adhesiveness. However, since the aminosilane is reacted with and bonded to the inorganic filler and the epoxy group of the epoxy resin contained in the resin composition at a relatively low temperature, there is a case that the aminosilane can not be sufficiently reacted with and bonded to a metal surface. On the other hand, in the case where a silane coupling agent having a secondary amine structure is used as the coupling agent (F), the resin composition has the flowability and the soldering resistance in a good balanced manner and at a high level.

This is because since the polyvalent hydroxyphenylene structural unit included in the polymer component of the phenol resin-based curing agent (A) has acidity, by using the silane coupling agent having the secondary amine structure with higher basicity in combination therewith, the polyvalent hydroxyphenylene structural unit and the silane coupling agent having the secondary amine structure are considered to exhibit a capping effect with each other by generating acid-base interaction therebetween.

Namely, due to this capping effect, reaction of the silane coupling agent having the secondary amine structure with the epoxy resin and reaction of the phenol resin-based curing agent (A) with the epoxy resin are delayed. This is considered to cause improvement of apparent flowability of the resin composition and further enhancement of adhesiveness or bonding strength with respect to the metal surface.

Examples of the silane coupling agent having the secondary amine structure which can be used in the present invention include, but are not limited to, N-β(aminoethyl) γ-aminopropyl trimethoxysilane, N-β(aminoethyl) γ-aminopropyl methyl dimethoxysilane, N-phenyl γ-aminopropyl triethoxysilane, N-phenyl γ-aminopropyl trimethoxysilane, N-β(aminoethyl) γ-aminopropyl triethoxysilane, N-6-(aminohexyl) 3-aminopropyl trimethoxysilane, N-(3-(trimethoxysilyl propyl)-1,3-benzene dimethanamine, and the like.

Among them, a silane coupling agent having a phenyl group and a secondary amine structure such as the N-phenyl γ-aminopropyl trimethoxysilane or the N-(3-(trimethoxysilyl propyl)-1,3-benzene dimethanamine is preferable from the viewpoints that the resin composition can exhibit excellent flowability and contamination of a mold by the resin composition can make small during continuous moldability thereof. As the coupling agent (F), one of the above aminosilanes may be used alone, two or more of them may be used in combination, or the above aminosilanes may be used in combination with the other silane coupling agent.

Examples of the other silane coupling agent which can be used in combination with the aminosilane include, but are not limited to, epoxysilane, aminosilane, ureidesilane, mercaptosilane and the like. Among them, preferable is a silane capable of improving interface strength between the epoxy resin (B) and the inorganic filler (C) by being reacted therewith. Further, by using the other silane coupling agent in combination with the compound (E), it also can enhance the effect of the compound (E) in which a melting viscosity of the resin composition is lowered to improve flowability thereof.

Examples of the epoxysilane include γ-glycidoxypropyl triethoxysilane, γ-glycidoxypropyl trimethoxysilane, γ-glycidoxypropyl methyl dimethoxysilane, β-(3,4-epoxycyclohexyl)ethyl trimethoxysilane and the like. Further, examples of the ureidesilane include γ-ureidepropyl triethoxysilane, hexamethyl disilazane and the like. Furthermore, a latent aminosilane coupling agent protected by reacting the primary amino portion of the aminosilane with a ketone or an aldehyde may be used.

Further, examples of the mercaptosilane include γ-mercaptopropyl trimethoxysilane, 3-mercaptopropyl methyl dimethoxysilane, a silane coupling agent which exhibits a function similar to the mercaptosilane coupling agent by being thermally decomposed such as bis(3-triethoxysylil propyl)tetrasulfide or bis(3-triethoxysylil propyl)disulfide, and the like. Furthermore, the other silane coupling agent may have been, in advance, subjected to a hydrolysis treatment. In this regard, one of the other silane coupling agents may be used alone, or two or more of them may be used in combination.

Among the other silane coupling agents which can be used in combination with the aminosilane, the epoxy silane is preferable from the viewpoints of having high adhesiveness with respect to an organic material such as polyimide provided on a silicon tip surface or a solder resist provided on a substrate surface, the mercaptosilane is preferable from the viewpoints of imparting continuous moldability to the resin composition.

A lower limit value of a mixing ratio of the coupling agent (F) such as the silane coupling agent which can be used in the resin composition for encapsulation is preferably 0.01 mass % or more, more preferably 0.05 mass % or more, and even more preferably 0.1 mass % or more with respect to the whole resin composition. If the lower limit value of the mixing ratio of the coupling agent (F) such as the silane coupling agent is within the above range, it is possible to obtain good solder clacking resistance in the electronic component device without lowering interface strength between the epoxy resin (B) and the inorganic filler (C).

On the other hand, an upper limit value of the mixing ratio of the coupling agent (F) such as the silane coupling agent is preferably 1 mass % or less, more preferably 0.8 mass % or less, and even more preferably 0.6 mass % or less with respect to the whole resin composition. If the upper limit value of the mixing ratio of the coupling agent (F) such as the silane coupling agent is within the above range, it is possible to obtain good solder clacking resistance in the electronic component device without lowering interface strength between the epoxy resin (B) and the inorganic filler (C).

Further, if the mixing ratio of the coupling agent (F) such as the silane coupling agent is within the above range, it is also possible to obtain the good solder clacking resistance in the electronic component device without increasing moisture absorption of a cured product of the resin composition.

The resin composition for encapsulation according to the present invention may contain an inorganic flame retardant (G) in order to improve flame resistance thereof. A metal hydroxide or a composite metal hydroxide capable of preventing burning reaction of the resin composition due to dehydration and heat absorption thereof when being burned from the viewpoints of shortening a burning time of the resin composition.

Examples of the metal hydroxide include aluminum hydroxide, magnesium hydroxide, calcium hydroxide, barium hydroxide and zirconia hydroxide. The composite metal hydroxide is a hydrotalcite compound containing two or more metal elements, and preferably a hydrotalcite compound in which one of the metal elements is magnesium and another metal element is an element selected from the group consisting of calcium, aluminum, tin, titanium, iron, cobalt, nickel, copper and zinc. As the composite metal hydroxide, a solid solution of magnesium hydroxide-zinc hydroxide is commercially available in an easy manner.

Among them, the aluminum hydroxide and the solid solution of magnesium hydroxide-zinc hydroxide are preferable from the viewpoints of imparting soldering resistance and continuous moldability to the resin composition in a balanced manner. As the inorganic flame retardant (G), one of the hydroxides may be used alone, or two or more of them may be used in combination. Further, in order to reduce an effect on continuous moldability of the resin composition, the inorganic flame retardant (G) may be subjected to a surface treatment using a silicon compound such as a silane coupling agent, an aliphatic compound such as a wax or the like.

The resin composition for encapsulation according to the present invention may optionally contain: a coloring agent such as carbon black, red oxide or titanium oxide; a natural wax such as carnauba wax; a synthetic wax such as polyethylene wax; a releasing agent such as a higher fatty acid and a metal salt thereof (e.g., stearic acid, zinc stearate) or paraffin; and a low stress additive such as a silicon oil or a silicone rubber in addition to the above components.

The resin composition for encapsulation according to the present invention can be prepared by uniformly mixing the phenol resin-based curing agent (A), the epoxy resin (B), the inorganic filler (C), the above mentioned other additive and the like with each other at normal temperature, for example, using a mixer or the like, optionally melted and kneaded using a kneading machine such as a heating roller, a kneader or an extruder, and then optionally cooled and crushed to thereby adjust dispersity, flowability or the like to predetermined degrees.

[Electronic Component Device]

Next, an electronic component device according to the present invention will be described. Examples of a method of manufacturing the electronic component device using the resin composition for encapsulation according to the present invention include a method in which a lead frame or a circuit substrate on which an element is mounted is placed into a cavity of a mold, and the resin composition for encapsulation is molded using a molding process such as a transfer molding process, a compression molding process or an injection molding process and cured to thereby encapsulate the element.

Examples of the element to be encapsulated include, but are not limited to, an integrated circuit, a large-scale integrated circuit, a transistor, a thyristor, a diode, a solid-state image sensing device and the like. More preferable examples of the element include an integrated circuit, a large-scale integrated circuit, a transistor, a thyristor, a diode, a solid-state image sensing device and the like each used in a car, and an element in which SiC (carbon silicon) or GaN (gallium nitride) is used.

Examples of a constituent material of the lead frame include, but are not limited to, copper, a copper alloy, a 42 metal alloy (Fe-42% Ni metal alloy) and the like. A surface of the lead frame may be subjected to a plating such as a strike plating of pure copper, a silver plating (mainly, on a wire joint portion of an inner lead tip) or a multiple plating of nickel/palladium/gold (PPF (Palladium Pre-Plated Frame)). As a result, the copper, the copper alloy, the gold or the 42 metal alloy exists on a portion of the surface of the lead frame having low adhesiveness.

Examples of a type of the obtained electronic component device include, but are not limited to, a package used in a memory or a logic type device such as a dual inline package (DIP), a chip carrier with plastic-lead (PLCC), a quad flat package (QFP), a low profile quad flat package (LQFP), a small outline package (SOP), a small outline J lead package (SOJ), a thinned small outline package (TSOP), a thinned quad flat package (TQFP), a tape carrier package (TCP), a ball grid array (BGA), a chip size package (CSP), a matrix array package ball grid array (MAPBGA) or a chip stacked chip size package, a package in which a power-type device (e.g., power transistor) is provided such as TO-220, and the like.

The electronic component device in which the element is encapsulated by molding the resin composition for encapsulation using the molding process such as the transfer molding process is added to electronic equipment or the like directly or after the resin composition is fully cured at a temperature of about 80 to 200° C. for a time of about 10 minutes to 10 hours.

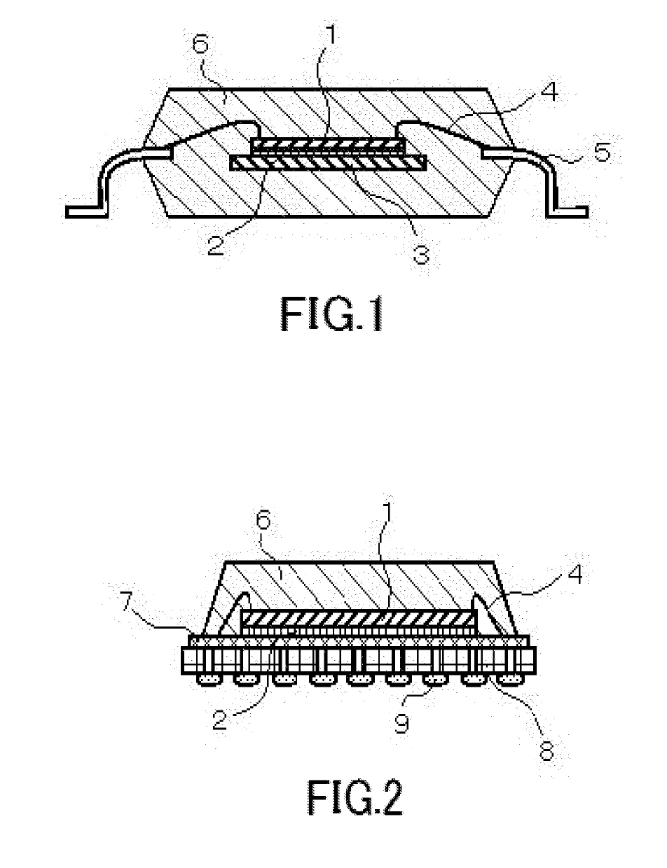

FIG. 1 is a view showing a cross section structure of one example of the electronic component device produced using the resin composition for encapsulation according to the present invention. A semiconductor element 1 is fixed on a die pad 3 through a cured product 2 of a die bonding agent. Electrode pads of the semiconductor element 1 and a lead frame 5 are bonding together through wires 4. The semiconductor element 1 is encapsulated by a cored product 6 of the resin composition for encapsulation.

FIG. 2 is a view showing a cross section structure of one example of a single side-encapsulated type electronic component device produced using the resin composition for encapsulation according to the present invention. A semiconductor element 1 is fixed on a substrate 8 through a solder resist 7 and a cured product 2 of a die bonding agent. Electrode pads of the semiconductor element 1 and electrode pads of the substrate 8 are bonding together through wires 4. Only one surface of the substrate 8 on which the semiconductor element 1 is mounted is encapsulated by a cured product 6 of the resin composition for encapsulation according to the present invention.

The electrode pads provided on the substrate 8 and solder balls 9 provided on a non-encapsulated surface of the substrate 8 are connected together thereinside. By encapsulating the semiconductor element 1 using the resin composition for encapsulation according to the present invention, the electronic component device can have excellent reliability. Further, by doing so, productivity of the electronic component device becomes good, and thus it can be economically obtained.

### EXAMPLES

Hereinafter, the present invention will be described in detail with reference to specific examples, but is not limited to the descriptions of these examples.

Description will be made on each component used in Examples and Comparative Examples described below. In this regard, a mixing amount of each component is indicated as a part by mass unless otherwise described.

Further, an ICI viscosity at 150° C. of each of various epoxy resins and various phenol resin-based curing agents was measured using a high temperature ICI-type corn plate rotating viscosimeter produced by M.S.T ENGINEERING K.K. (a plate temperature was set to 150° C., a 5P corn was used)

[Synthesis of Phenol Resin-Based Curing Agent 1]

A stirrer, a thermometer, a reflux condenser and a nitrogen introduction port were attached to a separable flask. 504 parts by mass of 1,3-dihydroxybenzene (“resorcinol” produced by TOKYO CHEMICAL INDUSTRY CO., LTD., melting point: 111° C., molecular weight: 110, purity: 99.4%), 141 parts by mass of phenol (special grade reagent “phenol” produced by KANTO CHEMICAL CO., INC., melting point: 41° C., molecular weight: 94, purity: 99.3%) and 251 parts by mass of 4,4′-bischloromethyl biphenyl (“4,4′-bischloromethyl biphenyl” produced by Wako Pure Chemical Industries, Ltd., melting point: 126° C., purity: 95%, molecular weight: 251) were weighed into the separable flask, heated while the inside of the separable flask was replaced with a hydrogen gas, and then the stirring thereof was started at the time when the phenol was melted.

They were reacted with each other for 3 hours while maintaining a system inside temperature within a range of 110 to 130° C., and then reacted with each other for 3 hours while maintaining the system inside temperature within a range of 140 to 160° C. by being heated. A chlorine gas generated in the system due to the above reaction was discharged therefrom by a nitrogen stream. After the completion of reaction, unreacted components were distilled away therefrom under the reduced pressure conditions of 2 mmHg at 150° C.

Next, 400 parts by mass of toluene were added to and uniformly dissolved into them to obtain a solution. Thereafter, the solution was transferred into a separating funnel, and then a washing operation, in which a water layer was disposed after 150 parts by mass of a distilled water was added to the solution and shaken, was repeatedly carried out until the water layer neutralized. Next, volatile components such as the toluene and the residual unreacted components were distilled away from an oil layer by subjecting it to a reduced pressure treatment of 2 mmHg at 150° C.

In this way, obtained was a phenol resin-based curing agent 1 composed of polymer components each by the following formula (12) (hydroxyl equivalent: 126, ICI viscosity at 150° C.: 8.7 dPa·s, softening point: 101° C., both ends of structural formula: hydrogen atoms). In this regard, the polymer components contained a polymer component (A-1) represented by the general formula (1) with “k”≧1 and “m”≧1 and a polymer component (A-2) represented by the general formula (1) with “k”=0 and “m”≧2.

In this regard, the monovalent hydroxyphenylene structural unit repeating “k” times and the polyvalent hydroxyphenylene structural unit repeating “m” times continuously, alternately or randomly existed, and the biphenylene group-containing structural unit repeating “k+m−1” times bonded the monovalent hydroxyphenylene structural units together, the polyvalent hydroxyphenylene structural units together or the monovalent hydroxyphenylene structural unit and the polyvalent hydroxyphenylene structural unit together.

Further, percentages of the polymer components (A-1) to (A-3) obtained by dividing a total of relative intensities of peaks derived from the polymer component (A-1), a total of relative intensities of peaks derived from the polymer component (A-2) and a total of relative intensities of peaks derived from a polymer component (A-3) by a total of relative intensities of peaks derived from the whole phenol resin-based curing agent 1 by a field desorption mass spectrometry (FD-MS) analysis were 38%, 58% and 4%, respectively.

Furthermore, an average value “k0” of the numbers “k” of the monovalent hydroxyphenylene structural units included in the polymer components, an average number “m0” of the numbers “m” of the polyvalent hydroxyphenylene structural units included therein and a ratio thereof “K0/m0” were 0.78, 1.77 and 30.5/69.5, respectively. In this regard, the average values “k0” and “m0” were obtained by an arithmetic calculation considering a relative intensity ratio of the polymer components based on the FD-MS analysis as a mass ratio thereof.

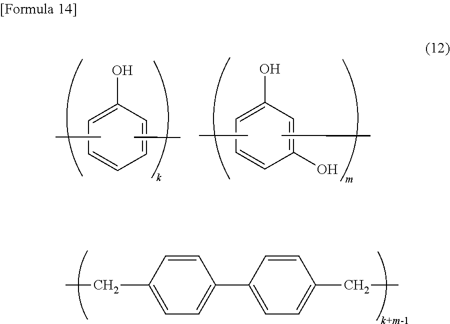

[Synthesis of Phenol Resin-Based Curing Agents 2 to 5]

A synthesis operation was carried out except that mixing amounts of the 1,3-dihydroxybenzene, the phenol and the 4,4′-bischloromethyl biphenyl were changed as shown in Table 1.

In this way, obtained were phenol resin-based curing agents 2 to 5 each composed of polymer components each represented by the above formula (12) (both ends of structural formula: hydrogen atoms). In this regard, the polymer components contained a polymer component (A-1) represented by the general formula (1) with “k”≧1 and “m”≧1 and a polymer component (A-2) represented by the general formula (1) with “k”=0 and “m”≧2.

In this regard, the monovalent hydroxyphenylene structural unit repeating “k” times and the polyvalent hydroxyphenylene structural unit repeating “m” times continuously, alternately or randomly existed, and the biphenylene group-containing structural unit repeating “k+m−1” times bonded the monovalent hydroxyphenylene structural units together, the polyvalent hydroxyphenylene structural units together or the monovalent hydroxyphenylene structural unit and the polyvalent hydroxyphenylene structural unit together. Further, the phenol resin-based curing agent 4 contained only the polymer component (A-2).

Furthermore, in each of the obtained phenol resin-based curing agents 2 to 5, a hydroxyl equivalent, an ICI viscosity at 150° C., a softening point, percentages of the polymer components (A-1) to (A-3) each based on a total of relative intensities measured by a field desorption mass spectrometry (FD-MS) analysis, average values “k0” and “m0” obtained by an arithmetic calculation considering a relative intensity ratio of the polymer components based on a FD-MS analysis as a mass ratio thereof, and a ratio “K0/m0” of the average values “k0” and “m0” are shown in Table 1.

TABLE 1

| | | Phenol resin- | Phenol resin- | Phenol resin- | Phenol resin- | Phenol resin- |
|---|---|---|---|---|---|---|
| | | type curing | type curing | type curing | type curing | type curing |
| | | agent 1 | agent 2 | agent 3 | agent 4 | agent 5 |
| Mixing amounts of raw materials of phenol | | | | | | |
| resin-type curing agent | | | | | | |
| 1,3-dihydroxybenzene | Parts by mass | 504 | 360 | 216 | 720 | 108 |
| Phenol | Parts by mass | 141 | 235 | 329 | 0 | 400 |
| 4,4′-bischloromethyl biphenyl | Parts by mass | 251 | 251 | 251 | 251 | 251 |
| Properties of phenol resin-type curing agent | | | | | | |
| Hydroxyl equivalent | g/eq | 126 | 135 | 159 | 120 | 175 |
| ICI viscosity at 150° C. | dPa · sec | 8.7 | 4.7 | 3.1 | 16.2 | 1.7 |
| Softening point | ° C. | 101 | 95 | 82 | 112 | 75 |
| Percentage of polymer component based on total of | | | | | | |
| relative intensities measured by FD-MS analysis | | | | | | |
| Polymer component (A-1) | % | 38 | 19 | 11 | 0 | 3 |
| Polymer component (A-2) | % | 58 | 64 | 33 | 100 | 17 |
| Polymer component (A-3) | % | 4 | 17 | 56 | 0 | 80 |

| Average value of numbers of structural units by | | | | | | |
|---|---|---|---|---|---|---|
| FD-MS analysis | | | | | | |
| Average value “k0” of numbers “k” of monovalent | — | 0.78 | 1.20 | 1.80 | 0.00 | 2.06 |
| hydroxyphenylene structural units | | | | | | |
| Average number “m0” of numbers “m” of | — | 1.77 | 1.27 | 0.64 | 3.60 | 0.36 |
| polyvalent hydroxyphenylene structural units | | | | | | |
| “k0”/“m0” | — | 30.5/69.5 | 48.6/51.4 | 73.8/26.2 | 0/100 | 85.1/14.9 |
| “k0” + “m0” | — | 2.55 | 2.47 | 2.44 | 3.60 | 2.42 |

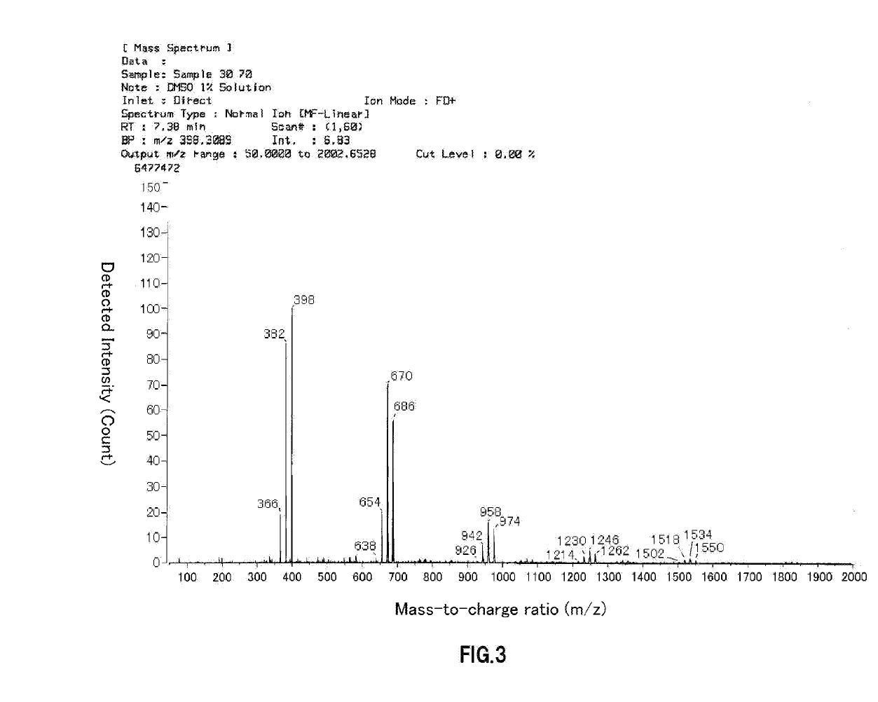

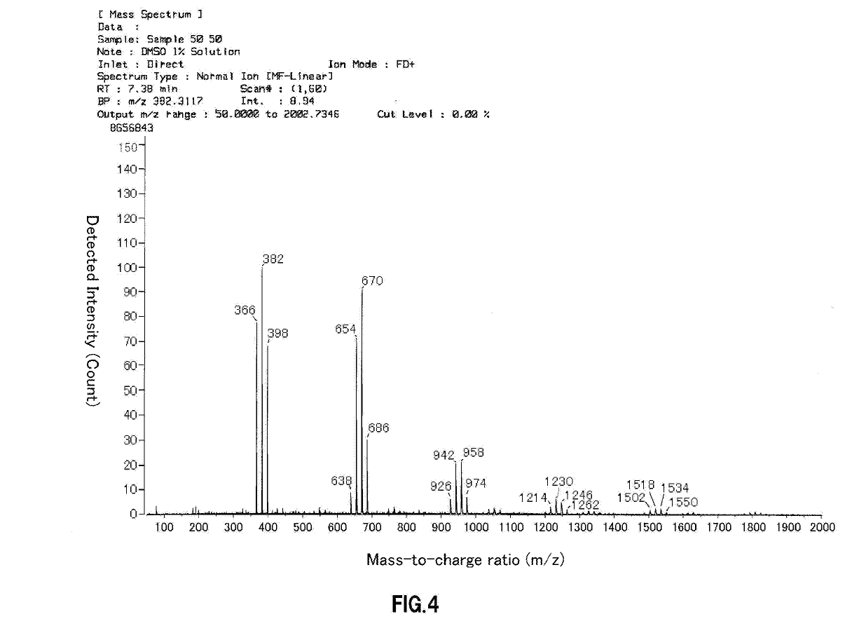

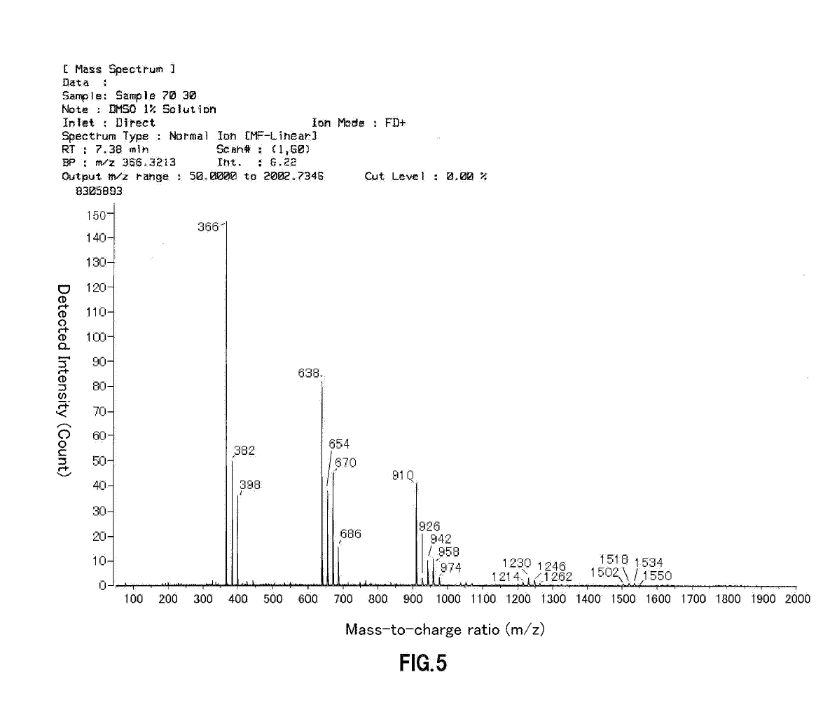

A FD-MS chart of the phenol resin-type curing agent 1 is shown in FIG. 3, a FD-MS chart of the phenol resin-type curing agent 2 is shown in FIG. 4, and a FD-MS chart of the phenol resin-type curing agent 3 is shown in FIG. 5. In each of the charts of the phenol resin-type curing agents 1, 2 and 3, it is confirmed that a peak having m/z=382 (derived from the polymer component (A-1) represented by the general formula (1) or (12) with “k”=1 and “m”=1), a peak having m/z=398 (derived from the polymer component (A-2) represented by the general formula (1) or (12) with “k”=0 and “m”=2) and a peak having m/z=366 (derived from the polymer component (A-3) represented by the general formula (1) or (12) with “k”=2 and “m”=0) exist.

Further, it is confirmed that only each of the phenol resin-type curing agents 1, 2 and 3 corresponds to a phenol resin-type curing agent (A) in which a total of relative intensities of peaks derived from the polymer component (A-1) is preferably in the range of 5 to 80% with respect to a total of relative intensities of peaks derived from the whole phenol resin-based curing agent, and a total of relative intensities of peaks derived from the polymer component (A-2) is preferably in the range of 20 to 75% with respect to the total of relative intensities of the peaks derived from the whole phenol resin-based curing agent.

In this regard, a FD-MS measurement of the phenol resin-type curing agents 1 to 5 was carried out as follows. 1 g of dimethyl sulfoxide (DMSO) being a solvent was added to 10 mg of a sample of the phenol resin-type agent so that the sample was sufficiently dissolved into the dimethyl sulfoxide to obtain a sample solution, and then a FD emitter to which the sample solution was applied was provided to the measurement. The measurement was carried out using a FD-MS system connecting MS-FD15A (produced by JEOL Ltd.) to an ionization potion and connecting a double focus-type mass spectroscope (“MS-700” produced by JEOL Ltd.) to detector within a detection mass range (m/z) of 50 to 2000.

As another phenol resin-type curing agent, the following phenol resin-type curing agent 6 was used.

Phenol resin-type curing agent 6: Phenol aralkyl resin having a biphenylene chemical structure (“MEH-7851SS” produced by MEIWA PLASTIC INDUSTRIES, LTD., hydroxyl equivalent: 203 g/eq, ICI viscosity at 150° C.: 0.68 dPa·sec, softening point: 67° C.)

The phenol resin-type curing agent 6 corresponded to a phenol resin consisting of the polymer component (A-3) represented by the general formula (1) or (12) with “k”≧2 and “m”=0.

As the epoxy resin (B), the following epoxy resins 1 to 15 were used.

Epoxy resin 1: Biphenyl-type epoxy resin (“YX4000K” produced by Mitsubishi Chemical Corporation, epoxy equivalent: 185, melting point: 107° C., ICI viscosity at 150° C.: 0.1 dPa·s)

Epoxy resin 2: Bisphenol F-type epoxy resin (“YSLV-80XY” produced by Tohto Kasei Co., Ltd., epoxy equivalent: 190, melting point: 80° C., ICI viscosity at 150° C.: 0.03 dPa·s)

Epoxy resin 3: Bisphenol A-type epoxy resin (“YL6810” produced by Mitsubishi Chemical Corporation, epoxy equivalent: 172, melting point: 45° C., ICI viscosity at 150° C.: 0.03 dPa·s)

Epoxy resin 4: Sulfide-type epoxy resin represented by the following general formula (13) (“YSLV-120TE” produced by Nippon Steel Chemical Co., Ltd., epoxy equivalent: 240, melting point: 120° C., ICI viscosity at 150° C.: 0.2 dPa·s)

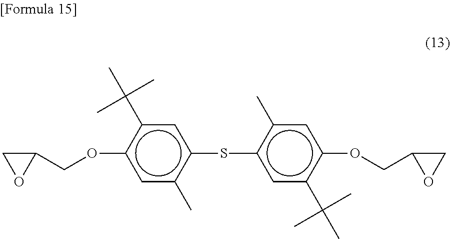

Epoxy resin 5: A stirrer, a thermometer, a reflux condenser and a nitrogen introduction port were attached to a separable flask. 100 parts by mass of phenolphthalein (produced by TOKYO CHEMICAL INDUSTRY CO., LTD.) and 350 parts by mass of epichlorohydrin (produced by TOKYO CHEMICAL INDUSTRY CO., LTD.) were weighed into the separable flask, and then dissolved by being heated at 90° C. to obtain a solution. Thereafter, 50 parts by mass of sodium hydroxide (solid fine granular, purity: 99%) was gradually added to the solution for 4 hours, and then the solution was heated at 100° C. to react them with each other for 3 hours.

Next, a washing operation, in which a water layer was disposed after 200 parts by mass of toluene was added to and dissolved into the solution, and then 150 parts by mass of a distilled water was added thereto and shaken, was repeatedly carried out until the water layer neutralized. Thereafter, the epichlorohydrin was distilled away from an oil layer by subjecting it to a reduced pressure treatment at 125° C. to obtain a solid product. 250 parts by mass of methyl isobutyl ketone was added to the solid product to dissolve it so that a solution was obtained.

The solution was heated at 70° C., 13 parts by mass of a 30% sodium hydroxide aqueous solution was added thereto for 1 hour, the solid product and the sodium hydroxide were further reacted with each other for 1 hour, and then a water layer was disposed after leaving the solution. A water washing operation, in which a water layer was disposed after 150 parts by mass of a distilled water was added to the residue oil layer, was repeatedly carried out until the water layer neutralized, and then the methyl isobutyl ketone was distilled away from the oil layer by being heated and depressurized.

In this way, obtained was an epoxy resin containing a compound represented by the following formula (14) (hydroxyl equivalent: 235 g/eq, softening point: 67° C., ICI viscosity at 150° C.: 1.1 dPa·s.

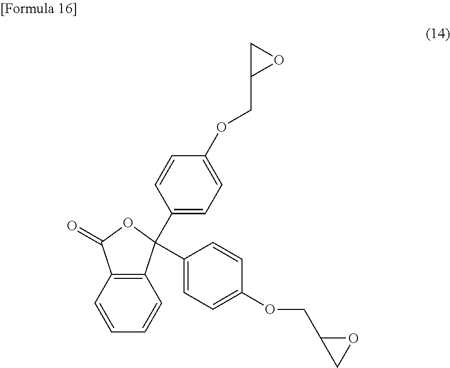 [SMILES: O=C1OC(c2ccc(OCC3CO3)cc2)(c2ccc(OCC3CO3)cc2)c2ccccc21]

Epoxy resin 6: Dihydroxyanthracene-type epoxy resin (“YX8800” produced by Mitsubishi Chemical Corporation, epoxy equivalent: 181, melting point: 110° C., ICI viscosity at 150° C.: 0.11 dPa·s)

Epoxy resin 7: Triphenylmethane-type epoxy resin (“1032H-60” produced by Mitsubishi Chemical Corporation, epoxy equivalent: 171, softening point: 60° C., ICI viscosity at 150° C.: 1.3 dPa·s)

Epoxy resin 8: Tetrakisphenylethane-type epoxy resin (“1031S” produced by Mitsubishi Chemical Corporation, epoxy equivalent: 196, softening point: 92° C., ICI viscosity at 150° C.: 11.0 dPa·s)

Epoxy resin 9: Polyfunctional naphthalene-type epoxy resin (“HP-4770” produced by DIC corporation, epoxy equivalent: 205, softening point: 72° C., ICI viscosity at 150° C.: 0.9 dPa·s)

Epoxy resin 10: Phenolaralkyl-type epoxy resin having a biphenylene chemical structure (“NC3000” produced by NIPPON KAYAKU CO., LTD., epoxy equivalent: 276, softening point: 58° C., ICI viscosity at 150° C.: 1.1 dPa·s)

Epoxy resin 11: Phenolaralkyl-type epoxy resin having a phenylene chemical structure (“NC2000” produced by NIPPON KAYAKU CO., LTD., epoxy equivalent: 238, softening point: 52° C., ICI viscosity at 150° C.: 1.2 dPa·s)

Epoxy resin 12: An epoxy resin represented by the following formula (15) (epoxy equivalent: 262, softening point: 67° C., ICI viscosity at 150° C.: 2.4 Pa·s) was obtained in the same manner as the synthesis operation of the epoxy resin 5, except that the phenolphthalein was changed to 100 parts by mass of phenol-modified xylene-formaldehyde resin (“Xister GP-90” produced by Fudow Co., Ltd., hydroxyl equivalent: 197, softening point: 86° C.) and the mixing ratio of the epichlorohydrin was changed.

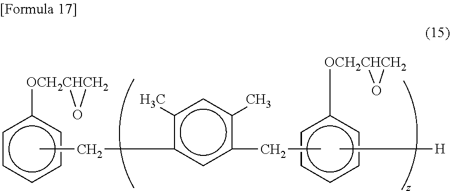

Epoxy resin 13: Methoxynaphthalene chemical structure containing novolac-type epoxy resin (“EXA-7320” produced by DIC corporation, epoxy equivalent: 251, softening point: 58° C., ICI viscosity at 150° C.: 0.85 dPa·s)

Epoxy resin 14: Orthocresolnovolac-type epoxy resin (“N-660” produced by DIC corporation, epoxy equivalent: 210, softening point: 62° C., ICI viscosity at 150° C.: 2.34 dPa·s)

Epoxy resin 15: A stirrer, a thermometer, a reflux condenser and a nitrogen introduction port were attached to a separable flask. 100 parts by mass of the above phenol resin-based curing agent 2 and 400 parts by mass of epichlorohydrin (produced by TOKYO CHEMICAL INDUSTRY CO., LTD.) were weighed into the separable flask, and then dissolved by being heated at 100° C. to obtain a solution. Thereafter, 60 parts by mass of sodium hydroxide (solid fine granular, purity: 99%) was gradually added to the solution for 4 hours, and then reacted with each other for 3 hours.

Next, a washing operation, in which a water layer was disposed after 200 parts by mass of toluene was added to and dissolved into the solution, and then 150 parts by mass of a distilled water was added thereto and shaken, was repeatedly carried out until the water layer neutralized. Thereafter, the epichlorohydrin was distilled away from an oil layer by subjecting it to a reduced pressure treatment of 2 mmHg at 125° C. to obtain a solid product. 300 parts by mass of methyl isobutyl ketone was added to the solid product to be dissolve it so that a solution was obtained.

The solution was heated at 70° C., 13 parts by mass of a 30% sodium hydroxide aqueous solution was added thereto for 1 hour, the solid product and the sodium hydroxide were further reacted with each other for 1 hour, and then a water layer was disposed after leaving the solution to obtain an oil layer. A water washing operation was repeatedly carried out by adding 150 parts by mass of a distilled water to the oil layer until a water layer neutralized, and then the methyl isobutyl ketone was removed from the oil layer by being heated and depressurized.

In this way, obtained was an epoxy resin 15 in which the hydroxyl groups of the above phenol resin-based curing agent 2 compound were substituted with glycidyl ether groups (epoxy equivalent: 190 g/eq).

As the inorganic filler (C), used was a blended material (inorganic filler 1) in which 100 parts by mass of a fused spherical silica having an average particle size of 30 μm (“FB560” produced by DENKI KAGAKU KOGYO KABUSHIKI KAISHA), 6.5 parts by mass of a synthetic spherical silica having an average particle size of 0.5 μm (“SO-C2” produced by Admatechs Company Limited) and 7.5 parts by mass of a synthetic spherical silica having an average particle size of 30 μm (“SO-05” produced by Admatechs Company Limited) were mixed with each other.

As the curing accelerator (D), used were the following curing accelerator 1 to 5.

Curing Accelerator 1: Curing Accelerator Represented by the Following Formula (16)

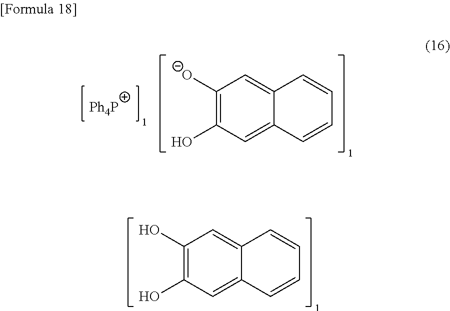

Curing Accelerator 2: Curing Accelerator Represented by the Following Formula (17)

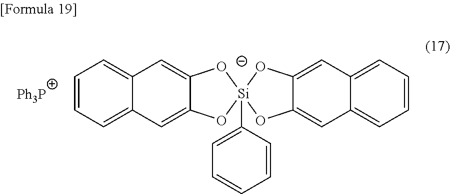

Curing Accelerator 3: Curing Accelerator Represented by the Following Formula (18)

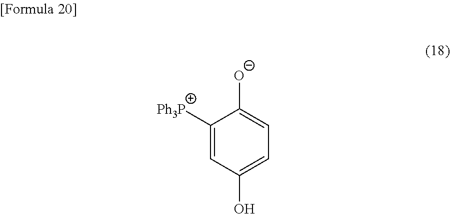

Curing Accelerator 4: Curing Accelerator Represented by the Following Formula (19)

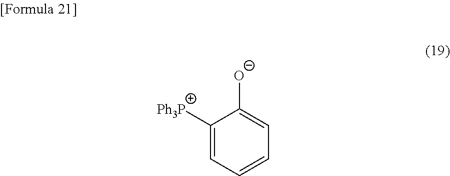

Curing Accelerator 5: Triphenyl Phosphine

As the compound (E), used was a compound represented by the following formula (20) (“2,3-naphthalenediol” produced by Tokyo Kasei Kogyo Co., Ltd., purity: 98%).

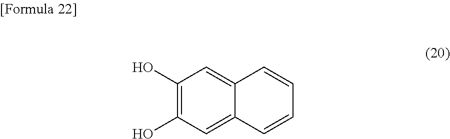 [SMILES: Oc1cc2ccccc2cc1O]

As the coupling agent (F), used were the following silane coupling agents 1 to 3.

Coupling agent 1: γ-mercaptopropyl trimethoxysilane (“KBM-803” produced by Shin-Etsu Chemical Co., Ltd.)

Coupling agent 2: γ-glycidoxypropyl trimethoxysilane (“KBM-403” produced by Shin-Etsu Chemical Co., Ltd.)

Coupling agent 3: N-phenyl-3-aminopropyl trimethoxysilane (“KBM-573” produced by Shin-Etsu Chemical Co., Ltd.)

As the inorganic flame retardant (G), used were the following inorganic flame retardants 1 and 2.

Inorganic flame retardant 1: Aluminum hydroxide being a metal hydroxide (“CL-303” produced by Sumitomo Chemical Co., Ltd.)

Inorganic flame retardant 2: Solid solution of magnesium hydroxide-zinc hydroxide being a composite metal hydroxide (“ECOMAG Z-10” produced by Tateho Chemical Industries Co., Ltd.)

As the coloring agent, used was carbon black (“MA600” produced by Mitsubishi Chemical Corporation).

As the releasing agent, used was carnauba wax (“Nikko Carnauba” produced by Nikko Fine Product Co., melting point: 83° C.)

On a resin composition for encapsulation obtained in each of Examples and Comparative Examples described below, the following measurement and evaluation were carried out.

(Evaluation Item)

Spiral flow: The resin composition was injected into a mold for spiral flow measurement according to ANSI/ASTM D 3123-72 using a low pressure transfer molding machine (“KTS-15” produced by Kohtaki Precision Machine Co., Ltd.) under the conditions that a temperature was 175° C., an injection pressure was 6.9 MPa and a pressure keeping time was 120 seconds, and then a flow length thereof was measured. Spiral flow is a flowability parameter, and the larger a value of the spiral flow, the more preferable the flowability of the resin composition. An unit of the spiral flow is “cm”.

When considering use of the resin composition in a dual inline package (DIP) and a small outline package (SOP) and a small outline J lead package (SOJ), it is preferred that the spiral flow thereof is 60 cm or more. Further, when considering use of the resin composition in a chip carrier with plastic lead (PLCC), a quad flat package (QFP) and a low profile quad flat package (LQFP), it is preferred that the spiral flow thereof is 80 cm or more.

Furthermore, when considering use of the resin composition in a thinned small outline package (TSOP), a thinned quad flat package (TQFP), a tape carrier package (TCP), a ball grid array (BGA), a chip size package (CSP), a matrix array package ball grid array (MAPBGA) and a chip stacked chip size package, it is preferred that the spiral flow thereof is 110 cm or more.

Flame resistance: A sample for flame resistance test having a thickness of 3.2 mm was produced by injecting the resin composition into a mold using a low pressure transfer molding machine (“KTS-30 produced by Kohtaki Precision Machine Co., Ltd.) under the conditions that a mold temperature was 175° C., an injection time was 15 seconds, a curing time was 120 seconds and an injection pressure was 9.8 MPa. On the obtained sample, the flame resistance test was carried out according to a standard of an UL94 normal beam technique. In Tables, ΣF, Fmax and flame resistance rank (class) after the judgment are shown.

Continuous moldability: The obtained resin composition was molded into tablets using a powder molding press machine (“S-20-A” produced by Tamagawa machinery Corporation) at a making-tablet pressure of 600 Pa so as to have a weight of 15 g and a size of φ18 mm×a height of about 30 mm. A tablet supply magazine into which the obtained tablets were loaded was set inside molding equipment. An operation, in which a silicon chip and the like were encapsulated with the resin composition using a low pressure transfer automatic molding machine (“GP-ELF” produced by Dai-ichi Seiko Co., Ltd.) as the molding equipment under the conditions that a mold temperature was 175° C., a molding pressure was 9.8 Mpa and a curing time was 120 seconds to thereby obtain a 80 pin QFP (lead frame made of Cu, package outer size: 14 mm×20 mm×2.0 mm thickness, pad size: 8.0 mm×8.0 mm, chip size: 7.0 mm×7.0 mm×0.35 mm thickness), was continuously carried out 400 times (shots).

During this operation, a state that the mold surface was contaminated or not contaminated and a state that the packages were molded or not molded (that is, existence or nonexistence of unfilled portion) were confirmed every 25 shots. The number of the shots that the contamination of the mold could be first confirmed is shown in the item “mold contamination” of each Table, or the “A” mark is also shown therein in the case where the contamination of the mold did not occur. Further, the number of the shots that generation of an unfilled portion could be first confirmed is shown in the item “filling defect” of each Table, or the “A” mark is also shown therein in the case where the unfilled portion did not be generated. In this regard, the contamination of the mold surface is not preferable because there is a case that the resin composition of the mold surface is transferred on a surface of the molded semiconductor device or a case that the contamination of the mold surface gives signs of generating the unfilled portion.

Further, before the tablets are actually used in the molding, they are in a standby state that a maximum of 13 tablets are vertically piled and loaded in the magazine of the molding equipment at a surface temperature of about 30° C. During supply conveyance of the tablets in the molding equipment, the tablet located in a top line is pushed out of an upper part of the magazine due to rising of a knocking-up pin from a lowermost part of the magazine, and then lifted with a mechanical arm to thereby be conveyed into a pot for transfer molding. At this time, if the up and down tablets are bonded together in the magazine during the standby state, a conveyance defect occurs. In this regard, the number of the shots that occurrence of the conveyance defect could be first confirmed is shown in the item “conveyance defect” of each Table, or the “A” mark is also shown therein in the case where the conveyance defect did not occur.

Soldering resistance test 1: 12 semiconductor devices were respectively produced by encapsulating a lead frame on which a semiconductor element (silicon chip) was mounted and the like with the resin composition using a low pressure transfer automatic molding machine (“GP-ELF” produced by Dai-ichi Seiko Co., Ltd.) under the conditions that a mold temperature was 180° C., an injection pressure was 7.4 Mpa and a curing time was 120 seconds. In this regard, each of the semiconductor device was composed of a 80 pin QFP (lead frame which was made of Cu and whose surface was subjected to a strike plating, size: 14 mm×20 mm×2.00 mm thickness, the semiconductor element had a size of 7 mm×7 mm×0.35 mm thickness and was bonded to the inner lead part of the lead frame through a gold wire having a diameter of 25 μm).

The 12 semiconductor devices were subjected to a heat treatment at 175° C. for 4 hours as a post-cure, subjected to a humidification treatment in relative humidity of 60% at 85° C. for 168 hours, and then subjected to an IR reflow treatment (260° C. condition). Existence or nonexistence of delamination and crack inside these semiconductor devices was observed with an ultrasonic reflectscope (“mi-scope10” produced by Hitachi Kenki FineTech Corporation) and a semiconductor device in which any one of the delamination or the crack was generated was defined as “defect”. When the number of the semiconductor devices defined as “defect” is “n”, “n/12” is shown in each Table. In the case where the number of defect is 1/12 or less, this result is determined as “good”.

Soldering resistance test 2: A soldering resistance test 2 was carried out in the same manner as the soldering resistance test 1, except that the humidification treatment was performed in relative humidity of 85% at 85° C. for 120 hours. In the case where the number of defect is 3/12 or less, this result is determined as “good”.

High temperature storage life (HTSL): 20 semiconductor devices were respectively produced by encapsulating a lead frame on which a semiconductor element (silicon chip) was mounted and the like with the resin composition for encapsulation using a low pressure transfer automatic molding machine (“GP-ELF” produced by Dai-ichi Seiko Co., Ltd.) under the conditions that a mold temperature was 180° C., an injection pressure was 6.9±0.17 Mpa and a curing time was 90 seconds.

In this regard, each of the 20 semiconductor devices was composed of a 16 pins-type Dual Inline Package (DIP) in which a lead frame was made of a 42 metal alloy and had a size of 7 mm×11.5 mm×1.8 mm thickness, the semiconductor element had a size of 5 mm×9 mm×0.35 mm thickness, had an oxide film having a thickness of 5 μm and formed on a surface thereof and an aluminum wiring pattern having a line and space of 10 μm and formed on the oxide film, and aluminum wiring pad portions and lead frame pad portions were bonded together through a gold wire having a diameter of 25 μm.

The 20 semiconductor devices were subjected to a heat treatment at 175° C. for 4 hours as a post-cure, and then an initial resistance value thereof was measured. Thereafter, each of them was subjected to a high temperature storage treatment at 185° C. for 1,000 hours, and then a resistance value thereof was measured. A semiconductor device whose resistance value after the high temperature storage treatment became 125% of the initial resistance value thereof was defined as “defect”. When the number of the semiconductor devices defined as “defect” is “n”, “n/20” is shown in each Table. In the case where the number of defect is 2/20 or less, this result is determined as “good”.

In each of Examples and Comparative Examples, the respective components were mixed with each other according to mixing amounts shown in each of Tables 3, 4 and 5 at normal temperature using a mixer, melted and kneaded using heat rolls having a temperature of 80 to 100° C., cooled, and then ground to thereby obtain a resin composition for encapsulation. On the obtained resin composition for encapsulation, the above mentioned measurement and evaluation were carried out. These results are shown in Tables 2, 3 and 4.

TABLE 2

| | | Example | | | | | | | | | |
|---|---|---|---|---|---|---|---|---|---|---|---|
| | | 1 | 2 | 3 | 4 | 5 | 6 | 7 | 8 | 9 | 10 |
| Phenol resin-based | 1 | 5.50 | | | | | | | | | |
| curing agent | 2 | | 5.73 | | 5.64 | 5.98 | 4.88 | 4.94 | 5.81 | | |
| | 3 | | | 6.29 | | | | | | 6.44 | 6.20 |
| | 4 | | | | | | | | | | |
| | 5 | | | | | | | | | | |
| | 6 | | | | | | | | | | |
| Epoxy resin | 1 | 8.48 | 8.25 | 7.69 | | | | | | 3.77 | 3.89 |
| | 2 | | | | 8.34 | | | | | | |
| | 3 | | | | | 8.00 | | | | | |
| | 4 | | | | | | 9.10 | | | | |
| | 5 | | | | | | | 9.04 | | | |
| | 6 | | | | | | | | 8.17 | | |
| | 7 | | | | | | | | | 3.77 | |
| | 8 | | | | | | | | | | 3.89 |
| | 9 | | | | | | | | | | |
| | 10 | | | | | | | | | | |
| | 11 | | | | | | | | | | |
| | 12 | | | | | | | | | | |
| | 13 | | | | | | | | | | |
| | 14 | | | | | | | | | | |
| Inorganic filler 1 | | 85 | 85 | 85 | 85 | 85 | 85 | 85 | 85 | 85 | 85 |
| Curing accelerator | 1 | 0.40 | 0.40 | 0.40 | 0.40 | 0.40 | 0.40 | 0.40 | 0.40 | 0.40 | 0.40 |
| | 2 | | | | | | | | | | |
| | 3 | | | | | | | | | | |
| | 4 | | | | | | | | | | |
| | 5 | | | | | | | | | | |
| Compound (E) | | | | | | | | | | | |
| Silane coupling | 1 | 0.07 | 0.07 | 0.07 | 0.07 | 0.07 | 0.07 | 0.07 | 0.07 | 0.07 | 0.07 |
| agent | 2 | 0.07 | 0.07 | 0.07 | 6.07 | 0.07 | 0.07 | 0.07 | 0.07 | 0.07 | 0.07 |
| | 3 | 0.08 | 0.08 | 0.08 | 0.08 | 0.08 | 0.08 | 0.08 | 0.08 | 0.08 | 0.08 |
| Inorganic flame | 1 | | | | | | | | | | |
| retardant | 2 | | | | | | | | | | |

| Carbon black | | 0.3 | 0.3 | 0.3 | 0.3 | 0.3 | 0.3 | 0.3 | 0.3 | 0.3 | 0.3 |
|---|---|---|---|---|---|---|---|---|---|---|---|
| Carnauba wax | | 0.1 | 0.1 | 0.1 | 0.1 | 0.1 | 0.1 | 0.1 | 0.1 | 0.1 | 0.1 |
| Spiral flow [cm] | | 122 | 112 | 112 | 124 | 131 | 121 | 82 | 128 | 74 | 72 |
| Flame | ΣF [second] | 15 | 16 | 14 | 13 | 12 | 13 | 2 | 2 | 12 | 18 |
| resistance | Fmax [second] | 6 | 4 | 5 | 6 | 5 | 6 | 1 | 1 | 4 | 6 |
| | Rank | V-0 | V-0 | V-0 | V-0 | V-0 | V-0 | V-0 | V-0 | V-0 | V-0 |
| Continuous | Mold | 350 | 375 | 375 | 350 | 350 | 350 | A | A | 400 | A |
| moldability | contamination | | | | | | | | | | |
| | Filling defect | A | A | A | A | A | A | A | A | A | A |
| | Conveyance | A | A | A | A | A | A | A | A | A | A |
| | defect | | | | | | | | | | |

| | | | | | | | | | | | |
|---|---|---|---|---|---|---|---|---|---|---|---|
| Soldering resistance test | 1 | 0/12 | 0/12 | 0/12 | 0/12 | 0/12 | 0/12 | 0/12 | 0/12 | 0/12 | 0/12 |
| (defect number in n = 12) | 2 | 1/12 | 2/12 | 1/12 | 1/12 | 1/12 | 0/12 | 0/12 | 2/12 | 1/12 | 1/12 |

| | | | | | | | | | | |
|---|---|---|---|---|---|---|---|---|---|---|
| High temperature storage | 1/20 | 2/20 | 1/20 | 2/20 | 1/20 | 2/20 | 0/20 | 0/20 | 0/20 | 0/20 |
| life (HTSL) | | | | | | | | | | |

TABLE 3

| | | Example | | | | | | | | | |
|---|---|---|---|---|---|---|---|---|---|---|---|
| | | 11 | 12 | 13 | 14 | 15 | 16 | 17 | 18 | 19 | 20 |
| Phenol resin-based | 1 | | 4.92 | 5.12 | 4.98 | | | | | | |
| curing agent | 2 | | | | | 5.26 | 5.52 | 5.79 | 5.87 | 5.87 | 5.87 |
| | 3 | 6.12 | | | | | | | | | |
| | 4 | | | | | | | | | | |
| | 5 | | | | | | | | | | |
| | 6 | | | | | | | | | | |
| Epoxy resin | 1 | 3.93 | 4.53 | 4.43 | 4.50 | 4.36 | 4.23 | | | | |
| | 2 | | | | | | | | | | |
| | 3 | | | | | | | | | | |
| | 4 | | | | | | | | | | |
| | 5 | | | | | | | | | | |
| | 6 | | | | | | | 8.14 | 8.26 | 8.26 | 8.26 |
| | 7 | | | | | | | | | | |
| | 8 | | | | | | | | | | |
| | 9 | 3.93 | | | | | | | | | |
| | 10 | | 4.53 | | | | | | | | |
| | 11 | | | 4.43 | | | | | | | |
| | 12 | | | | 4.50 | | | | | | |
| | 13 | | | | | 4.36 | | | | | |
| | 14 | | | | | | 4.23 | | | | |
| Inorganic filler 1 | | 85 | 85 | 85 | 85 | 85 | 85 | 85 | 85 | 85 | 85 |
| Curing accelerator | 1 | 0.40 | 0.40 | 0.40 | 0.40 | 0.40 | 0.40 | | | | |
| | 2 | | | | | | | 0.45 | | | |
| | 3 | | | | | | | | 0.25 | | |
| | 4 | | | | | | | | | 0.25 | |
| | 5 | | | | | | | | | | 0.20 |
| Compound (E) | | | | | | | | | | | 0.05 |
| Silane coupling | 1 | 0.07 | 0.07 | 0.07 | 0.07 | 0.07 | 0.07 | 0.07 | 0.07 | 0.07 | 0.07 |
| agent | 2 | 0.07 | 0.07 | 0.07 | 0.07 | 0.07 | 0.07 | 0.07 | 0.07 | 0.07 | 0.07 |
| | 3 | 0.08 | 0.08 | 0.08 | 0.08 | 0.08 | 0.08 | 0.08 | 0.08 | 0.08 | 0.08 |
| Inorganic flame | 1 | | | | | | | | | | |
| retardant | 2 | | | | | | | | | | |

| Carbon black | | 0.3 | 0.3 | 0.3 | 0.3 | 0.3 | 0.3 | 0.3 | 0.3 | 0.3 | 0.3 |
|---|---|---|---|---|---|---|---|---|---|---|---|
| Carnauba wax | | 0.1 | 0.1 | 0.1 | 0.1 | 0.1 | 0.1 | 0.1 | 0.1 | 0.1 | 0.1 |
| Spiral flow [cm] | | 104 | 72 | 72 | 81 | 82 | 77 | 120 | 134 | 129 | 134 |
| Flame | ΣF [second] | 4 | 12 | 14 | 11 | 3 | 24 | 1 | 1 | 2 | 3 |
| resistance | Fmax [second] | 1 | 6 | 5 | 5 | 1 | 7 | 1 | 1 | 1 | 2 |
| | Rank | V-0 | V-0 | V-0 | V-0 | V-0 | V-0 | V-0 | V-0 | V-0 | V-0 |
| Continuous | Mold | 375 | 375 | 375 | 375 | 350 | A | A | 375 | 375 | A |
| moldability | contamination | | | | | | | | | | |
| | Filling defect | A | A | A | A | A | A | A | A | A | A |
| | Conveyance | A | A | A | A | A | A | A | A | A | A |
| | defect | | | | | | | | | | |

| | | | | | | | | | | | |
|---|---|---|---|---|---|---|---|---|---|---|---|
| Soldering resistance test | 1 | 0/12 | 0/12 | 0/12 | 0/12 | 0/12 | 0/12 | 0/12 | 0/12 | 0/12 | 0/12 |
| (defect number in n = 12) | 2 | 2/12 | 0/12 | 0/12 | 0/12 | 1/12 | 1/12 | 1/12 | 0/12 | 0/12 | 0/12 |

| | | | | | | | | | | |
|---|---|---|---|---|---|---|---|---|---|---|
| High temperature storage | 0/20 | 2/20 | 1/20 | 2/20 | 0/20 | 2/20 | 0/20 | 0/20 | 0/20 | 0/20 |
| life (HTSL) | | | | | | | | | | |

TABLE 4

| | | Example | | | | | Comparative Example | | | | |
|---|---|---|---|---|---|---|---|---|---|---|---|
| | | 21 | 22 | 23 | 24 | 25 | 1 | 2 | 3 | 4 | 6 |
| Phenol resin-based | 1 | | 5.50 | 5.50 | | | | | | | |
| curing agent | 2 | 6.41 | | | 4.88 | 5.55 | | | | | |
| | 3 | | | | | | | | | | |
| | 4 | | | | | | 5.34 | | | 3.06 | |
| | 5 | | | | | | | 6.63 | | | |
| | 6 | | | | | | | | 7.14 | 3.06 | 7.53 |
| Epoxy resin | 1 | | 8.48 | 8.48 | | | 8.64 | 7.35 | 6.84 | 7.86 | |
| | 2 | | | | | | | | | | |
| | 3 | | | | | | | | | | |
| | 4 | | | | 9.10 | | | | | | |
| | 5 | 11.72 | | | | | | | | | |
| | 6 | | | | | | | | | | |
| | 7 | | | | | | | | | | 6.35 |
| | 8 | | | | | | | | | | |
| | 9 | | | | | | | | | | |
| | 10 | | | | | | | | | | |
| | 11 | | | | | | | | | | |
| | 12 | | | | | | | | | | |
| | 13 | | | | | | | | | | |
| | 14 | | | | | | | | | | |
| | 15 | | | | | 8.43 | | | | | |
| Inorganic filler 1 | | 81 | 82 | 82 | 85 | 85 | 85 | 85 | 85 | 85 | 85 |
| Curing accelerator | 1 | | 0.40 | 0.40 | 0.40 | 0.40 | 0.40 | 0.40 | 0.40 | 0.40 | 0.40 |
| | 2 | | | | | | | | | | |
| | 3 | | | | | | | | | | |
| | 4 | | | | | | | | | | |
| | 5 | 0.20 | | | | | | | | | |
| Compound (E) | | 0.05 | | | | | | | | | |
| Silane coupling | 1 | 0.07 | 0.07 | 0.07 | 0.11 | 0.07 | 0.07 | 0.07 | 0.07 | 0.07 | 0.07 |
| agent | 2 | 0.07 | 0.07 | 0.07 | 0.11 | 0.07 | 0.07 | 0.07 | 0.07 | 0.07 | 0.07 |
| | 3 | 0.08 | 0.08 | 0.08 | | 0.08 | 0.08 | 0.08 | 0.08 | 0.08 | 0.08 |
| Inorganic flame | 1 | | 3.0 | | | | | | | | |
| retardant | 2 | | | 3.0 | | | | | | | |

| Carbon black | | 0.3 | 0.3 | 0.3 | 0.3 | 0.3 | 0.3 | 0.3 | 0.3 | 0.3 | 0.3 |
|---|---|---|---|---|---|---|---|---|---|---|---|
| Carnauba wax | | 0.1 | 0.1 | 0.1 | 0.1 | 0.1 | 0.1 | 0.1 | 0.1 | 0.1 | 0.1 |
| Spiral flow [cm] | | 110 | 113 | 111 | 95 | 100 | 45 | 129 | 134 | 80 | 80 |
| Flame | ΣF [second] | 4 | 3 | 4 | 14 | 3 | 42 | 11 | 3 | 29 | 46 |
| resistance | Fmax [second] | 2 | 2 | 2 | 6 | 2 | 13 | 7 | 2 | 7 | 15 |
| | Rank | V-0 | V-0 | V-0 | V-0 | V-0 | V-1 | V-0 | V-0 | V-0 | V-1 |
| Continuous | Mold | A | A | A | 350 | — | A | 225 | 200 | 175 | — |
| moldability | contamination | | | | | | | | | | |
| | Filling defect | A | A | A | A | — | 125 | 250 | 225 | 200 | — |
| | Conveyance | A | A | A | A | — | A | A | A | A | — |
| | defect | | | | | | | | | | |

| | | | | | | | | | | | |
|---|---|---|---|---|---|---|---|---|---|---|---|
| Soldering resistance test | 1 | 0/12 | 0/12 | 0/12 | 0/12 | — | 11/12 | 0/12 | 0/12 | 4/12 | — |
| (defect number in n = 12) | 2 | 0/12 | 1/12 | 2/12 | 3/12 | — | 12/12 | 7/12 | 5/12 | 9/12 | — |

| | | | | | | | | | | |
|---|---|---|---|---|---|---|---|---|---|---|
| High temperature storage | 0/20 | 1/20 | 1/20 | 2/20 | — | 2/20 | 14/20 | 11/20 | 9/20 | — |
| life (HTSL) | | | | | | | | | | |
| Tg [DMA tanδ] | — | — | — | — | 230 | — | — | — | — | 270 |
| Weight loss ratio | — | — | — | — | 0.08 | — | — | — | — | 0.41 |

The resin composition for encapsulation obtained in each of Examples 1 to 24 includes the phenol resin-based curing agent (A) essentially containing the polymer component (A-1) represented by the general formula (1) with “k”≧1 and “m”≧1 and the polymer component (A-2) represented by the general formula (1) with “k”=0 and “m”≧2, the epoxy resin (B) and the inorganic filler (C). In this regard, the total of relative intensities of the peaks derived from the polymer component (A-1) is 5% or more with respect to the total of relative intensities of the peaks derived from the whole phenol resin-based curing agent (A) by the field desorption mass spectrometry analysis.

Further, in the general formula (1), the monovalent hydroxyphenylene structural unit repeating “k” times and the polyvalent hydroxyphenylene structural unit repeating “m” times continuously, alternately or randomly exist, and the biphenylene group-containing structural unit repeating “k+m−1” times bonds the monovalent hydroxyphenylene structural units together, the polyvalent hydroxyphenylene structural units together or the monovalent hydroxyphenylene structural unit and the polyvalent hydroxyphenylene structural unit together.

One of these resin compositions for encapsulation is a resin compositions in which the kind of the phenol resin-based curing agent (A) is changed, the kind of the epoxy resin (B) is changed, the mixing amount of the inorganic filler (C) is changed, the kind of the curing accelerator (D), the compound (E) is added thereto, the kind of the coupling agent (F) is changed, the inorganic flame retardant (G) is added thereto or the like. Each of these resin compositions for encapsulation exhibits frowability (spiral flow), flame resistance, continuous moldability (mold contamination, filling property, conveying property), soldering resistance and high temperature storage life in an excellent balanced manner.

Further, in the resin composition for encapsulation obtained in each of Examples 1 to 24, by using the specific epoxy resin (B), the curing accelerator (D), the compound (E) and the coupling agent (F) together with the phenol resin-based curing agent (A) as a curing agent, it has become apparent that the following effects can be obtained.

The resin composition for encapsulation obtained in each of Examples 1 to 6, 8 and 17 to 20, in which only the epoxy resins 1 to 4 and 6 being the crystalline epoxy resins are used as the epoxy resin (B), exhibits especially excellent flowability.

The resin composition for encapsulation obtained in each of Examples 9 to 11, in which the epoxy resins 7 to 9 being the polyfunctional epoxy resins are used as the epoxy resin (B), exhibits especially excellent high temperature storage life.

The resin composition for encapsulation obtained in each of Examples 7 and 21, in which the epoxy resin 5 being the phenolphthalein-type epoxy resin is used as the epoxy resin (B), exhibits excellent flame resistance, high temperature storage life, soldering resistance and continuous moldability, even in the case where the amount of the inorganic filler contained therein is small.

The resin composition for encapsulation obtained in each of Examples 12 to 14, in which the epoxy resins 10 to 12 being the phenol aralkyl-type epoxy resin or the phenol-modified aromatic hydrocarbon-formaldehyde resin-type epoxy resin are used as the epoxy resin (B), exhibits especially excellent soldering resistance.

The resin composition for encapsulation obtained in each of Examples 8, 11, 15 and 17 to 20, in which the epoxy resins 6, 9 and 13 being the epoxy resin having the naphthalene chemical structure or the anthracene chemical structure are used as the epoxy resin (B), exhibits especially excellent flame resistance and high temperature storage life.

The cured product of the resin composition for encapsulation obtained in Example 25, in which the epoxy resin 15 being the epoxy resin represented by the general formula (B1) is used as the epoxy resin (B), has a glass transition temperature (Tg) of 230° C. which is higher than these of the resin compositions for encapsulation obtained in Examples 1 to 24 being within 150 to 190° C. Further, it has a very low weight loss ratio as compared with the resin composition for encapsulation obtained in Comparative Example 5 whose cured product has a high glass transition temperature (Tg). Therefore, the resin composition for encapsulation obtained in Example 25 achieves both the improvement of the glass transition temperature (Tg) and the lowering of the weight loss ratio of the cured product thereof, while maintaining the flame resistance of the cured product and the flowability of the resin composition.

The resin composition for encapsulation obtained in each of Examples 8 and 17, in which the curing accelerators 1 and 2 being the tetra-substituted phosphonium compound and the adduct of the phosphine compound or the silane compound are used as the curing accelerator (D), exhibits especially excellent continuous moldability as compared with the other Examples (Examples 18 and 19) which contains the same components as Examples 8 and 17 except the curing accelerator (D).

The resin composition for encapsulation obtained in each of Examples 18 and 19, in which the curing accelerators 3 and 4 being the phosphobetaine compound or the adduct of the phosphine compound and the quinone compound are used as the curing accelerator (D), exhibits especially excellent flowability and soldering resistance as compared with the other Examples (Examples 8 and 17) which contains the same components as Examples 18 and 19 except the curing accelerator (D).

The resin composition for encapsulation obtained in each of Examples 20 and 21, in which the compound (E) is used, exhibits good flowability and excellent continuous moldability in spite of the use of the curing accelerator 5 being the phosphorus atom-containing curing accelerator having no latent as the curing accelerator (D).

The resin composition for encapsulation obtained in Example 6, in which the silane coupling agent being the silane coupling agent having the secondary amine structure is used as the silane coupling agent (F), exhibits especially excellent flowability and soldering resistance as compared with the other Example (Example 24) which contains the same components as Example 6 except the silane coupling agent (F).

On the other hand, the resin composition for encapsulation obtained in Comparative Example 1, in which the phenol resin-based curing agent 4 consisting of the polymer component (A-1) represented by the general formula (1) with “k”≧1 and “m”≧1 is used instead of the phenol resin-based curing agent (A), exhibits inferior flowability, flame resistance, continuous moldability and soldering resistance.

The resin composition for encapsulation obtained in Comparative Example 2, in which the phenol resin-based curing agent 5 whose total of relative intensities of the peaks derived from the polymer component (A-1) represented by the general formula (1) with “k”≧1 and “m”≧1 is less than 5% with respect to the total of relative intensities of the peaks derived from the whole phenol resin-based curing agent (A) is used instead of the phenol resin-based curing agent (A), exhibits inferior continuous moldability and high temperature storage life, and also exhibits inferior soldering resistance under the severe conditions.

The resin composition for encapsulation obtained in Comparative Example 3, in which the phenol resin-based curing agent 6 being the phenol aralkyl resin having the biphenylene chemical structure which corresponds to the phenol resin-based curing agent consisting of the polymer component (A-3) represented by the general formula (1) with “k”≧2 and “m”=0 is used instead of the phenol resin-based curing agent (A), exhibits inferior continuous moldability and high temperature storage life, and also exhibits inferior soldering resistance under the severe conditions.

The resin composition for encapsulation obtained in Comparative Example 4, in which a combination of the phenol resin-based curing agent 4 consisting of the polymer component (A-2) represented by the general formula (1) with “k”=0 and “m”≧2 and the phenol resin-based curing agent 6 being the phenol aralkyl resin having the biphenylene chemical structure which corresponds to the phenol resin-based curing agent consisting of the polymer component (A-3) represented by the general formula (1) with “k”≧2 and “m”=0 is used instead of the phenol resin-based curing agent (A), also exhibits inferior continuous moldability, soldering resistance and high temperature storage life.

The resin composition for encapsulation obtained in Comparative Example 5 has a high glass transition temperature (Tg) as compared with the resin composition for encapsulation obtained in Example 25, but does not have sufficient flame resistance. For this reason, it exhibits a large weight loss ratio of the cured product thereof under the high temperature conditions of 200° C. and 1,000 hours, and thus does not have sufficient flame resistance and heat resistance for utilizing in a car or a package in which a SiC element is used.

### INDUSTRIAL APPLICABILITY

According to the present invention, it is possible to economically obtain a resin composition for encapsulation having soldering resistance, flame resistance, continuous moldability, flowability, high temperature storage life and heat resistance in an excellent balanced manner, and an electronic component device produced by encapsulating an element with a cured product thereof and having high reliability.

For this reason, the resin composition for encapsulation is appropriately used in manufacturing an industrial resin encapsulation-type electronic component device, especially, a resin encapsulation-type electronic component device whose operational reliability is required under the more severe conditions such as in-car electronic equipment. Therefore, the present invention provides industrial applicability.

### EXPLANATION OF REFERENCES

1 Semiconductor element
2 Cured product of die bonding agent
3 Die pad
4 Wire
5 Lead frame
6 Cured product of resin composition for encapsulation
7 Solder resist
8 Substrate
9 Solder ball

1. A resin composition for encapsulation, comprising:
a phenol resin-based curing agent (A) essentially containing a polymer component (A-1) represented by the following general formula (1) with “k”≧1 and “m”≧1 and a polymer component (A-2) represented by the following general formula (1) with “k”=0 and “m”≧2;
an epoxy resin (B); and
an inorganic filler (C),
wherein a total of relative intensities of peaks derived from the polymer component (A-1) is 5% or more with respect to a total of relative intensities of peaks derived from the whole phenol resin-based curing agent (A) by a field desorption mass spectrometry analysis: 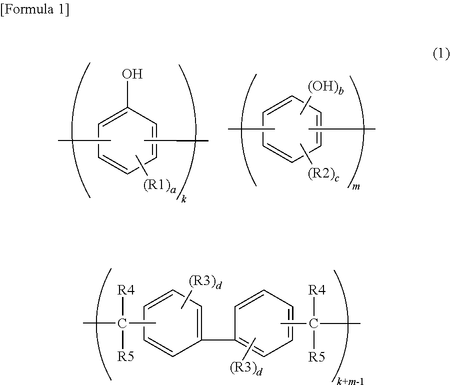
where each of R1 and R2 is independently a hydrocarbon group having a carbon number of 1 to 5, each of R3s is independently a hydrocarbon group having a carbon number or 1 to 10, and each of R4 and R5 is independently a hydrogen atom or a hydrocarbon group having a carbon number of 1 to 10,
“a” is an integer number of 0 to 3, “b” is an integer number of 2 to 4, “c” is an integer number of 0 to 2, and “d” is an integer number of 0 to 4,
each of “k” and “m” is independently an integer number of 0 to 10 and “k”+“m” is 2 or larger,
the monovalent hydroxyphenylene structural unit repeating “k” times and the polyvalent hydroxyphenylene structural unit repeating “m” times continuously, alternately or randomly exist, and
the biphenylene group-containing structural unit repeating “k+m−1” times bonds the monovalent hydroxyphenylene structural units together, the polyvalent hydroxyphenylene structural units together or the monovalent hydroxyphenylene structural unit and the polyvalent hydroxyphenylene structural unit together.

2. The resin composition for encapsulation as claimed in claim 1, wherein a total of relative intensities of peaks derived from the polymer component (A-2) is 75% or less with respect to the total of relative intensities of the peaks derived from the whole phenol resin-based curing agent (A) by the field desorption mass spectrometry analysis.

3. The resin composition for encapsulation as claimed in claim 1, wherein the total of relative intensities of the peaks derived from the polymer component (A-1) is in the range of 5 to 80% with respect to the total of relative intensities of the peaks derived from the whole phenol resin-based curing agent (A) and the total of relative intensities of the peaks derived from the polymer component (A-2) is in the range of 20 to 75% with respect to the total of relative intensities of the peaks derived from the whole phenol resin-based curing agent (A) by the field desorption mass spectrometry analysis.

4. The resin composition for encapsulation as claimed in claim 1, wherein a ratio of an average value “k0” of the numbers “k” of the monovalent hydroxyphenylene structural units included in the polymer components of the phenol resin-based curing agent (A) with respect to an average number “m0” of the numbers “m” of the polyvalent hydroxyphenylene structural units included therein is in the range of 18/82 to 82/18.

5. The resin composition for encapsulation as claimed in claim 1, wherein an average value “k0” of the numbers “k” of the monovalent hydroxyphenylene structural units included in the polymer components of the phenol resin-based curing agent (A) is in the range of 0.5 to 2.0.

6. The resin composition for encapsulation as claimed in claim 1, wherein an average value “m0” of the numbers “m” of the polyvalent hydroxyphenylene structural units included in the polymer components of the phenol resin-based curing agent (A) is in the range of 0.4 to 2.4.

7. The resin composition for encapsulation as claimed in claim 1, wherein an amount of the inorganic filler (C) contained in the resin composition for encapsulation is in the range of 70 to 93 mass % with respect to a total amount of the resin composition for encapsulation.

8. The resin composition for encapsulation as claimed in claim 1 further comprising a coupling agent (F).

9. The resin composition for encapsulation as claimed in claim 8, wherein the coupling agent (F) contains a silane coupling agent having a secondary amine structure.

10. The resin composition for encapsulation as claimed in claim 1, wherein a hydroxyl equivalent of the phenol resin-based curing agent (A) is in the range of 90 to 190 g/eq.

11. The resin composition for encapsulation as claimed in claim 1, wherein the epoxy resin (B) contains at least one epoxy resin selected from the group constituting of a crystalline epoxy resin, a polyfunctional epoxy resin, a phenolphthalein-type epoxy resin and a phenol aralkyl-type epoxy resin.

12. The resin composition for encapsulation as claimed in claim 1, wherein the epoxy resin (B) contains an epoxy resin represented by the following general formula (B1): 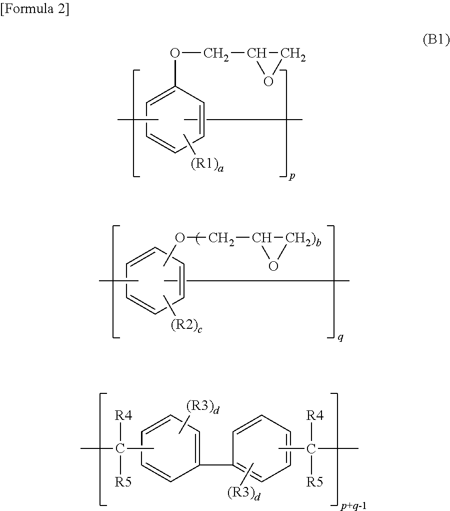
where each of R1 and R2 is independently a hydrocarbon group having a carbon number of 1 to 5, each of R3s is independently a hydrocarbon group having a carbon number or 1 to 10, and each of R4 and R5 is independently a hydrogen atom or a hydrocarbon group having a carbon number of 1 to 10,
“a” is an integer number of 0 to 3, “b” is an integer number of 2 to 4, “c” is an integer number of 0 to 2, and “d” is an integer number of 0 to 4, each of “p” and “q” is independently an integer number of 0 to 10 and “p”+“q” is 2 or larger,
the monovalent glycidylated phenylene structural unit repeating “p” times and the polyvalent glycidylated phenylene structural unit repeating “q” times continuously, alternately or randomly exist, and
the biphenylene group-containing structural unit repeating “p+q−1” times bonds the monovalent glycidylated phenylene structural units together, the polyvalent glycidylated phenylene structural units together or the monovalent glycidylated phenylene structural unit and the polyvalent glycidylated phenylene structural unit together.

13. The resin composition for encapsulation as claimed in claim 1 further comprising a curing accelerator (D).

14. The resin composition for encapsulation as claimed in claim 13, wherein the curing accelerator (D) contains at least one curing accelerator selected from the group constituting of a tetra-substituted phosphonium compound, a phosphobetaine compound, an adduct of a phosphine compound and a quinone compound and an adduct of a phosphonium compound and a silane compound.

15. The resin composition for encapsulation as claimed in claim 1 further comprising a compound (E) including an aromatic ring and hydroxyl groups bonding to two or more adjacent carbon atoms constituting the aromatic ring.

16. The resin composition for encapsulation as claimed in claim 1 further comprising an inorganic flame retardant (G).

17. The resin composition for encapsulation as claimed in claim 1 further comprising an inorganic flame retardant (G) containing a metal hydroxide or a composite metal hydroxide.

18. An electronic component device produced by encapsulating an element with a cured product of the resin composition for encapsulation defined by claim 1.
